(19) United States
(12) Patent Application Publication
(10) Pub. No.: US 2012/0108720 A1
(43) Pub. Date: May 3, 2012

(54) POLYLACTIC ACID-BASED RESIN COMPOSITION AND MOLDED ARTICLE

(75) Inventors: Yuji Kitora, Kyoto (JP); Kazue Ueda, Kyoto (JP); Takehito Saijo, Kyoto (JP); Yohei Kabashima, Kyoto (JP)

(73) Assignee: UNITIKA LTD., Hyogo (JP)

(21) Appl. No.: 13/319,405

(22) PCT Filed: Jul. 9, 2010
(86) PCT No.: PCT/JP2010/061668

§ 371 Date: Nov. 8, 2011

(30) Foreign Application Priority Data
Jul. 10, 2009 (JP) 2009-163213

(51) Int. Cl. C08K 5/29

(52) U.S. Cl. 524/195

(57) ABSTRACT

Disclosed is a polylactic acid-based resin composition including a polylactic acid resin, a monocarbodiimide compound and a hydrotalcite compound, wherein the content of the monocarbodiimide compound is 0.1 to 10 parts by mass in relation to 100 parts by mass of the polylactic acid resin and the content of the hydrotalcite compound is 0.05 to 2 parts by mass in relation to 100 parts by mass of the polylactic acid resin.

### TECHNICAL FIELD

The present invention relates to a polylactic acid-based resin composition and a molded article obtained from the polylactic acid-based resin composition.

### BACKGROUND ART

Nowadays, from the viewpoint of environmental preservation, various aliphatic polyester resins having biodegradability, typified by polylactic acid are attracting attention. Among such aliphatic polyester resins, polylactic acid resin is satisfactory in transparency and is one of the resins having the highest heat resistance; polylactic acid resin can be mass produced from raw materials derived from plants such as corn and sweet potato and hence is low in cost; further, polylactic acid resin can contribute to the reduction of the consumption amount of petroleum raw materials and hence is high in usefulness.

However, polylactic acid resin has a drawback of being low in hydrolysis resistance and durability in long-term use. In particular, under high temperature and high humidity, this tendency is extremely remarkable. The hydrolysis reaction of polylactic acid resin proceeds with the carboxyl groups as a catalyst at the molecular chain terminals, and in particular, the hydrolysis reaction proceeds in an accelerated manner under high temperature and high humidity. Therefore, a molded article produced with polylactic acid resin as a single substance disadvantageously causes the strength decrease and molecular weight decrease due to the deterioration caused by the use in a long term or under conditions of high temperature and high humidity, and is insufficient in the durability in long-term use and insufficient in the storage stability under high temperature and high humidity. In a long-term use under high temperature and high humidity, a molded article produced with polylactic acid resin as a single substance disadvantageously undergoes cracking, bleeding out, deformation and others to deteriorate the exterior appearance.

As a method for solving this problem, JP2001-261797A discloses a technique for improving the hydrolysis resistance by blocking the carboxyl groups at the molecular chain terminals of polylactic acid with a specific carbodiimide compound. However, in this method, the carboxyl terminals are sometimes incompletely blocked with the carbodiimide compound to allow some carboxyl terminals to remain, and sometimes allow the residues of the additives such as the carbodiimide compound to remain. These possibilities lead to an insufficient hydrolysis resistance to make difficult the long-term use or the use under the conditions of high temperature and high humidity.

JP2006-219567A describes an improvement of the hydrolysis rate achieved by adding a carbodiimide compound and a hydrotalcite compound to a polyester-based resin. In this case, however, the evaluation has been performed at such a low level based on the test period of 10 days under the conditions of 38° C. and a relative humidity of 85%, and the long-term hydrolysis resistance and the long-term durability are insufficient.

### SUMMARY OF INVENTION

### Technical Problem

An object of the present invention is to solve the above-described problems and to provide a polylactic acid-based resin composition excellent in hydrolysis resistance and durability and a molded article obtained from the polylactic acid-based resin composition.

### Solution to Problem

The present inventors performed a continuous diligent study for the purpose of solving the above-described problems, and consequently, have reached the present invention by discovering that in a polylactic acid-based resin composition including the polylactic acid resin in combination with a monocarbodiimide compound and a hydrotalcite compound, the hydrolysis resistance and the durability are significantly improved to an extent beyond anticipation (specifically, it is possible to obtain a molded article which, for a long term, is excellent in hydrolysis resistance, small in decrease of strength and satisfactory in exterior appearance). Further, the present inventors have reached the present invention by discovering that the use of a cross-linked polylactic acid resin improves the heat resistance of the polylactic acid-based resin composition and also the hydrolysis resistance and the durability of the polylactic acid-based resin composition.

Specifically, the gist of the present invention is the following (1) to (4).

(1) A polylactic acid-based resin composition including a polylactic acid resin, a monocarbodiimide compound and a hydrotalcite compound, wherein the content of the monocarbodiimide compound is 0.1 to 10 parts by mass in relation to 100 parts by mass of the polylactic acid resin and the content of the hydrotalcite compound is 0.05 to 2 parts by mass in relation to 100 parts by mass of the polylactic acid resin.

(2) The polylactic acid-based resin composition according to (1), wherein the polylactic acid resin is a cross-linked polylactic acid resin, and the polylactic acid-based resin composition includes a (meth)acrylic acid ester compound and/or a silane compound having two or more functional groups selected from an alkoxy group, an acryl group, a methacryl group and a vinyl group.

(3) The polylactic acid-based resin composition according to (1) or (2), wherein the polylactic acid-based resin composition includes a jojoba oil, and the content of the jojoba oil is 0.1 to 10 parts by mass in relation to 100 parts by mass of the polylactic acid resin.

(4) A molded article formed of the polylactic acid-based resin composition according to any one of (1) to (3).

### Advantageous Effects of Invention

The polylactic acid-based resin composition of the present invention includes a polylactic acid resin, and additionally a monocarbodiimide compound and a hydrotalcite compound, and hence it is possible to obtain a molded article excellent in hydrolysis resistance, and extremely excellent in durability in such a way that for a long term, the molded article is excellent in hydrolysis resistance, and also small in decrease of strength and satisfactory in exterior appearance. Additionally, by using a cross-linked polylactic acid resin as the polylactic acid resin, it is possible to obtain a polylactic acid-based resin composition excellent in heat resistance, and more improved in hydrolysis resistance and durability.

The polylactic acid-based resin composition of the present invention allows various molded articles to be obtained therefrom, and the molded article of the present invention formed of the polylactic acid-based resin composition of the present invention can be suitably utilized in various applications requiring hydrolysis resistance and durability. Moreover, the polylactic acid-based resin composition and the molded article of the present invention are obtained by using a plant-derived polylactic acid resin, and hence can contribute to alleviation of environmental load and prevention of depletion of petroleum resources.

### DESCRIPTION OF EMBODIMENTS

Hereinafter, the present invention is described in detail.

The polylactic acid-based resin composition of the present invention includes a polylactic acid resin, a monocarbodiimide compound and a hydrotalcite compound.

Hereinafter, the polylactic acid resin is described.

Among plant-derived materials, polylactic acid resin is excellent in moldability, transparency and heat resistance. Examples of polylactic acid resin may include poly(L-lactic acid), poly(D-lactic acid), and the mixtures, copolymers or stereocomplex eutectic mixtures of these.

In consideration of the easiness in industrial production, the polylactic acid resin is preferably such that the content ratio of poly(L-lactic acid) to poly(D-lactic acid), the L/D ratio (mol % ratio), is 0.05/99.95 to 99.95/0.05. The polylactic acid resin falling within this range of the L/D ratio can be used without any restriction.

In particular, when the L/D ratio (mol %) of the polylactic acid resin is 0.05/99.95 to 5/95 or the L/D ratio=99.95/0.05 to 95/5, preferably, the crystallinity is improved and, the heat resistance of the obtained resin composition is excellent and the hydrolysis resistance of the obtained resin composition is also improved.

The L/D ratio (mol %) of the polylactic acid resin in the present invention is calculated, as described later in Examples, by a method in which the L-lactic acid and D-lactic acid obtained by decomposing the polylactic acid resin are completely methyl esterified, then the methyl ester of L-lactic acid and the methyl ester of D-lactic acid are analyzed with a gas chromatography analyzer.

The weight average molecular weight (Mw) of the polylactic acid resin preferably falls within a range from 50,000 to 300,000, more preferably within a range from 80,000 to 250,000 and furthermore preferably within a range from 100,000 to 200,000. When the weight average molecular weight exceeds 300,000, the melt viscosity of the polylactic acid resin is increased, the fluidity at the time of melt-kneading is sometimes impaired to degrade the operability. On the other hand, when the weight average molecular weight is less than 50,000, disadvantageously the mechanical properties and the heat resistance are sometimes degraded. The weight average molecular weight (Mw) is a value determined at 40° C. relative to polystyrene standards by using a gel permeation chromatography (GPC) apparatus equipped with a differential refractive index detector and by using tetrahydrofuran as the eluent.

Additionally, when the melt viscosity is used as an index for molecular weight, the melt flow index (MFI) of the polylactic acid resin at 190° C. under a load of 2.16 kg preferably falls within a range from 0.1 g/10 min to 50 g/10 min and more preferably within a range from 0.2 to 40 g/10 min. When the melt flow index exceeds 50 g/10 min, the melt viscosity is too low, and the mechanical properties or the heat resistance of a molded article are sometimes poor. When the melt flow index is less than 0.1 g/10 min, the melt viscosity is too high and the load at the time of the molding processing of the resin composition comes to be too high, and consequently the operability is sometimes degraded. As a method for controlling the melt flow index so as to fall within a predetermined range, when the melt flow index is too large, a method in which a small amount of a chain extender, for example, a diisocyanate compound, a bisoxazoline compound, an epoxy compound or an acid anhydride is used to increase the molecular weight of the polylactic acid resin can be used. On the other hand, when the melt flow index is too small, examples of such a method include a method in which a low molecular weight compound having a large melt flow index such as a biodegradable polyester resin is mixed with the polylactic acid resin.

In the present invention, from the viewpoint of the molding processability, the melting point of the polylactic acid resin is preferably 140 to 240° C. and more preferably 150 to 220° C.

In the present invention, the polylactic acid resin is preferably a cross-linked polylactic acid resin prepared by introducing a cross-linked structure into a polylactic acid resin. By converting the polylactic acid resin into the cross-linked polylactic acid resin, the crystallization is promoted and the heat resistance is improved, and it is made possible to obtain a polylactic acid-based resin composition and a molded article more excellent in hydrolysis resistance and durability.

The cross-linked polylactic acid resin is a polylactic acid resin partially cross-linked by a well known conventional method, and may be modified (namely, graft polymerized) with a compound such as an epoxy compound.

The cross-linked polylactic acid resin in the present invention includes at least either a (meth)acrylic acid ester compound or a silane compound (hereinafter, abbreviated as “the silane compound in the present invention,” as the case may be) having two or more functional groups selected from an alkoxy group, an acryl group, a methacryl group and a vinyl group. The (meth)acrylic acid ester compound and the silane compound in the present invention are used as cross-linking agents, promote the cross-linking of the polylactic acid resin and the crystallization of the resin composition, and contribute to the improvement of the heat resistance and the further improvement of the hydrolysis resistance and the durability of the resin composition.

The (meth)acrylic acid ester compound is preferably a compound having in the molecule thereof two or more (meth)acryl groups or a compound having in the molecule thereof one or more (meth)acryl groups and one or more glycidyl groups or vinyl groups because such a (meth)acrylic acid ester compound is high in the reactivity with the polylactic acid resin, scarcely remains as a monomer, is low in toxicity and hardly colors the resin.

Specific examples of the (meth)acrylic acid ester compound include: glycidyl methacrylate, glycidyl acrylate, glycerol dimethacrylate, trimethylolpropane trimethacrylate, trimethylolpropane triacrylate, allyloxypolyethylene glycol monoacrylate, allyloxy(poly)ethylene glycol monomethacrylate, (poly)ethylene glycol dimethacrylate, (poly)ethylene glycol diacrylate, (poly)propylene glycol dimethacrylate, (poly) propylene glycol diacrylate, (poly)tetramethylene glycol dimethacrylate, the copolymers of these which are different in the alkylene length of the alkylene glycol moiety from each other, butanediol methacrylate and butanediol acrylate. From the viewpoint of the crystallization of the resin composition, preferable among these is (poly)ethylene glycol dimethacrylate.

The silane compound in the present invention is a silane compound having two or more functional groups selected from an alkoxy group, an acryl group, a methacryl group and a vinyl group, and is represented by the following formula (I):

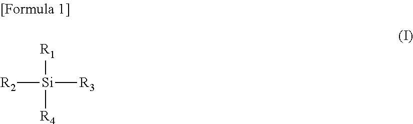

In formula (I), at least two or more of R₁ to R₄ represent the functional groups selected from an alkoxy group, an acryl group, a methacryl group and a vinyl group, or the substituents having these functional groups. The rest of R₁ to R₄ represent the groups other than an alkoxy group, an acryl group, a methacryl group and a vinyl group, and examples of the rest of R₁ to R₄ include a hydrogen atom, an alkyl group and an epoxy group.

Examples of the alkoxy group include a methoxy group and an ethoxy group. Examples of the substituent having a vinyl group include a vinyl group and a p-styryl group. Examples of the substituent having an acryl group include 3-methacryloxypropyl group and 3-acryloxypropyl group. Examples of the alkyl group include a methyl group and an ethyl group. Examples of the substituent having an epoxy group include 3-glycidoxypropyl group and 2-(3,4-epoxycyclohexyl) group.

From the viewpoint of the improvement of the crystallization rate, preferable among these compounds are the silane compounds having one functional group selected from an acryl group, a methacryl group and a vinyl group and having three alkoxy groups.

Specific examples and trade name examples of such silane compounds include: vinyltrimethoxysilane (KBM-1003, manufactured by Shin-Etsu Chemical Co., Ltd.), vinyltriethoxysilane (TSL8311, manufactured by GE Toshiba Silicones Co., Ltd.; KBE-1003, manufactured by Shin-Etsu Chemical Co., Ltd.), p-styryltrimethoxysilane (KBM-1403, manufactured by Shin-Etsu Chemical Co., Ltd.), 3-methacryloxypropyltrimethoxysilane (TSL8370, manufactured by GE Toshiba Silicones Co., Ltd.; KBM-503, manufactured by Shin-Etsu Chemical Co., Ltd.), 3-methacryloxypropyltriethoxysilane (KBE-503, manufactured by Shin-Etsu Chemical Co., Ltd.) and 3-acryloxypropyltrimethoxysilane (KBM-5103, manufactured by Shin-Etsu Chemical Co., Ltd.).

When a cross-linked polylactic acid resin is obtained by using such a (meth)acrylic acid ester compound as described above and the silane compound in the present invention, in the case where the (meth)acrylic acid ester compound and the silane compound in the present invention are used each alone, and in the case where the (meth)acrylic acid ester compound and the silane compound in the present invention are used in combination, the mixing amount (the total mixing amount of these two compounds) is preferably 0.01 to 5 parts by mass and, in particular, more preferably 0.05 to 3 parts by mass in relation to 100 parts by mass of the polylactic acid resin. When the mixing amount is less than 0.01 part by mass, the polylactic acid resin cannot be sufficiently cross-linked, and the crystallization cannot be sufficiently promoted, and hence the heat resistance sometimes cannot be improved. On the other hand, when the mixing amount exceeds 5 parts by mass, the operability at the time of kneading with the polylactic acid resin is degraded and the effect of the cross-linking is saturated, and hence the economic efficiency is sometimes poor.

As the method for introducing a cross-linked structure into the polylactic acid resin, a radical cross-linking method using a peroxide is preferable from the viewpoint of the cross-linking efficiency.

Specific examples of the peroxide include: benzoyl peroxide, bis(butylperoxy)trimethylcyclohexane, bis(butylperoxy)cyclododecane, butyl bis(butylperoxy)valerate, dicumyl peroxide, butyl peroxybenzoate, dibutyl peroxide, bis(butylperoxy)diisopropylbenzene, dimethyldi(butylperoxy)hexane, dimethyldi(butylperoxy)hexyne and butylperoxycumene. From the viewpoint of cross-linking efficiency, preferable among these is dibutyl peroxide.

The mixing amount of the peroxide is preferably 0.01 to 10 parts by mass, and in particular, preferably 0.05 to 5 parts by mass in relation to 100 parts by mass of the polylactic acid resin. By mixing the peroxide, the polylactic acid resin is efficiently and sufficiently cross-linked, and hence the crystallization is promoted and the heat resistance is improved. When the mixing amount of the peroxide is less than 0.01 part by mass, the effect of the addition of the peroxide is not found. The peroxide can be used in an amount exceeding 10 parts by mass; however, with such an amount, the effect of the peroxide is saturated, and moreover, the economic efficiency is sometimes poor. The peroxide is decomposed and consumed at the time of mixing with the polylactic acid resin, and hence the peroxide is sometimes not contained in the obtained resin composition.

More specifically, as a radical cross-linking method for obtaining a cross-linked polylactic acid resin, preferable is a method in which a peroxide, a (meth)acrylic acid ester compound and/or the silane compound in the present invention are mixed with the polylactic acid resin, and the resulting mixture is melt-kneaded with a common extruder. Additionally, it is preferable to use a double screw extruder for the purpose of attaining a satisfactory kneaded condition.

At the time of mixing, preferable is a method in which the peroxide, the (meth)acrylic acid ester compound and the silane compound in the present invention are dissolved or dispersed in a medium, and the resulting solution or dispersion is injected into the kneader. By kneading in this way, the operability can be remarkably improved. As the medium in which the peroxide, the (meth)acrylic acid ester compound and the silane compound in the present invention are dissolved or dispersed, a common medium is used and such medium is not particularly limited; however, among others, preferable as the medium is a plasticizer excellent in the compatibility with the polylactic acid resin.

Examples of such a plasticizer include one or more plasticizers selected from aliphatic polycarboxylic acid ester derivatives, aliphatic polyhydric alcohol ester derivatives, aliphatic oxyester derivatives, aliphatic polyether derivatives, aliphatic polyether polycarboxylic acid ester derivatives and the like. Specific examples of the plasticizer compound include glycerin diacetomonolaurate, glycerin diacetomonocaprate, polyglycerin acetic acid ester, polyglycerin fatty acid ester, medium-chain fatty acid triglyceride, dimethyl adipate, dibutyl adipate, triethylene glycol diacetate, methyl acetylrecinolate, acetyl tributylcitrate, polyethylene glycol, dibutyl diglycol succinate, bis(butyl diglycol)adipate and bis(methyl diglycol)adipate.

Commercially available plasticizers can be preferably used. Examples of the specific trade names of such commercially available plasticizers include: PL-012, PL-019, PL-320, PL-710, and Actor Series (M-1, M-2, M-3, M-4, M-107FR) manufactured by Riken Vitamin Co., Ltd.; ATBC manufactured by Taoka Chemical Co., Ltd.; BXA and MXA manufactured by Daihachi Chemical Industry Co., Ltd.; Chirabazol VR-01, VR-05, VR-10P, VR10P Modification 1, and VR-623 manufactured by Taiyo Kagaku Co., Ltd.

The mixing amount of the plasticizer is preferably 0.1 to 30 parts by mass and more preferably 0.1 to 20 parts by mass in relation to 100 parts by mass of the polylactic acid resin. When the mixing amount exceeds 30 parts by mass, unpreferably the heat resistance of the resin composition is sometimes degraded, or unpreferably the bleeding out of the molded article sometimes occurs. When the reactivity of the cross-linking agent is low, no plasticizer is required to be used. However, when the reactivity of the cross-linking agent is high, it is preferable to use a plasticizer in an amount of 0.1 part by mass or more because the plasticizer stabilizes the operability at the time of melt-kneading.

These plasticizers sometimes volatilize at the time of mixing with the polylactic acid resin, and hence the plasticizers are sometimes not contained in the obtained resin composition.

The polylactic acid-based resin composition of the present invention includes as a terminal blocking agent a carbodiimide compound, and it is necessary to use, among others, a monocarbodiimide compound. In the present invention, by using a monocarbodiimide compound and a hydrotalcite compound in combination, the hydrolysis resistance and the durability of the obtained resin composition or the obtained molded article can be improved.

Hereinafter, the monocarbodiimide compound is described.

The monocarbodiimide compounds used in the present invention are the compounds each having one carbodiimide group in one molecule thereof. Specific examples of the monocarbodiimide compound include: N,N′-di-2,6-diisopropylphenylcarbodiimide, N,N′-di-o-tolylcarbodiimide, N,N′-diphenylcarbodiimide, N,N′-dioctyldecylcarbodiimide, N,N′-di-2,6-dimethylphenylcarbodiimide, N-tolyl-N′-cyclohexylcarbodiimide, N,N′-di-2,6-di-tert-butylphenylcarbodiimide, N-tolyl-N′-phenylcarbodiimide, N,N′-di-p-nitrophenylcarbodiimide, N,N′-di-p-aminophenylcarbodiimide, N,N′-di-p-hydroxyphenylcarbodiimide, N,N′-di-cyclohexylcarbodiimide, N,N′-di-p-tolylcarbodiimide, p-phenylene-bis-di-o-tolylcarbodiimide, p-phenylene-bis-dicyclohexylcarbodiimide, hexamethylene-bis-dicyclohexylcarbodiimide, ethylene-bis-diphenylcarbodiimide, N,N′-benzylcarbodiimide, N-octadecyl-N′-phenylcarbodiimide, N-benzyl-N′-phenylcarbodiimide, N-octadecyl-N′-tolylcarbodiimide, N-cyclohexyl-N′-tolylcarbodiimide, N-phenyl-N′-tolylcarbodiimide, N-benzyl-N′-tolylcarbodiimide, N,N′-di-o-ethylphenylcarbodiimide, N,N′-di-p-ethylphenylcarbodiimide, N,N′-di-o-isopropylphenylcarbodiimide, N,N′-di-p-isopropylphenylcarbodiimide, N,N′-di-o-isobutylphenylcarbodiimide, N,N′-di-p-isobutylphenylcarbodiimide, N,N′-di-2,6-diethylphenylcarbodiimide, N,N′-di-2-ethyl-6-isopropylphenylcarbodiimide, N,N′-di-2-isobutyl-6-isopropylphenylcarbodiimide, N,N′-di-2,4,6-trimethylphenylcarbodiimide, N,N′-di-2,4,6-triisopropylphenylcarbodiimide, N,N′-di-2,4,6-triisobutylphenylcarbodiimide, diisopropylcarbodiimide, dimethylcarbodiimide, diisobutylcarbodiimide, dioctylcarbodiimide, t-butylisopropylcarbodiimide, di-β-naphthylcarbodiimide and di-t-butylcarbodiimide. These monocarbodiimide compounds may be used each alone or in combinations of two or more thereof. Preferable among the above-described monocarbodiimide compounds is N,N′-di-2,6-diisopropylphenylcarbodiimide from the viewpoint of the hydrolysis resistance, durability, maintenance of physical properties, maintenance of exterior appearance and the like.

The content of the monocarbodiimide compound in the polylactic acid-based resin composition is required to be 0.1 to 10 parts by mass and, in particular, is preferably 0.5 to 8 parts by mass in relation to 100 parts by mass of the polylactic acid resin or 100 parts by mass of the cross-linked polylactic acid resin. When the content is less than 0.1 part by mass, it is impossible to obtain a polylactic acid-based resin composition having hydrolysis resistance. On the other hand, when the content exceeds 10 parts by mass, the monocarbodiimide compound bleeds out to deteriorate the exterior appearance of the obtained molded article and to degrade the mechanical properties, such as the strength decrease, of the obtained molded article.

When a polycarbodiimide compound having two or more carbodiimide groups in one molecule thereof is used, such improvement effects of the hydrolysis resistance and the durability, as described below, obtained by using a hydrotalcite compound in combination are not found.

Hereinafter, the hydrotalcite compound is described.

The hydrotalcite compound in the present invention is an inorganic compound containing magnesium, zinc and aluminum. It has hitherto been known that a hydrotalcite compound is added to general-purpose synthetic resins such as polyolefin and polyvinyl chloride for the purpose of imparting thermal stability to the resins, or is added as an acid-accepting agent pH buffer. However, the effect of the addition of a hydrotalcite compound to the polylactic acid resin has not been known at all. The present inventors have discovered that the addition of a hydrotalcite compound together with the above-described monocarbodiimide compound to the polylactic acid resin improves the hydrolysis resistance and the durability of the obtained polylactic acid-based resin composition.

In other words, the hydrolysis resistance of the polylactic acid-based resin composition can be improved by adding a monocarbodiimide compound to the polylactic acid resin. In addition, by using a hydrotalcite compound together with a monocarbodiimide compound, the hydrolysis resistance and the durability of the polylactic acid-based resin composition can be improved to a large extent as compared to the case where the monocarbodiimide compound is contained alone. Even when the addition amount of the hydrotalcite compound is small, the effect of the hydrolysis resistance due to the addition of the monocarbodiimide compound can be more improved, and hence the content of the monocarbodiimide compound in the resin composition can be reduced. Accordingly, the effects, due to the addition of the monocarbodiimide compound and the hydrotalcite compound, on the other properties (the heat resistance, mechanical strength, exterior appearance and moldability) of the resin composition can be suppressed to the minimum. Moreover, the hydrotalcite compound has an effect to prevent the bleeding out of the monocarbodiimide compound and hence it is possible to obtain a molded article maintaining satisfactory exterior appearance for a long term. By reducing the content of the expensive carbodiimide compound, the cost for the resin composition can also be suppressed.

The hydrotalcite compound comprised in the polylactic acid-based resin composition of the present invention is preferably a hydrous basic carbonate containing magnesium and aluminum. Such a hydrous basic carbonate may be either natural or synthetic.

Natural products of the hydrotalcite compound has a chemical structure represented by Mg₆Al₂(OH)₁₆CO₃.4H₂0. On the other hand, examples of the synthetic product of the hydrotalcite compound include the products different in the compositional proportions of Mg and Al from the natural product, such as the products represented by the chemical formulas, Mg₄Al₂(OH)₁₂CO₃.3H₂0, Mg₅Al₂(OH)₁₄CO₃.4H₂0, Mg₁₀Al₂(OH)₂₂(CO₃)₂.4H₂0 and Mg_{4.5}Al₂(OH)₁₃CO₃.3.5H₂0. Such hydrotalcite compounds are readily available as commercial products, and can also be produced by heretofore known methods such as the hydrothermal method. These hydrotalcite compounds may be used each alone or in combinations of two or more thereof.

The content of the hydrotalcite compound is 0.05 to 2 parts by mass and preferably 0.5 to 1.5 parts by mass in relation to 100 parts by mass of the polylactic acid resin or 100 parts by mass of the cross-linked polylactic acid resin. When the content is less than 0.05 parts by mass, it is impossible to attain the improvement effect of the hydrolysis resistance and the durability of the obtained polylactic acid-based resin composition or the obtained molded article. On the other hand, when the content exceeds 2 parts by mass, the hydrolysis resistance of the polylactic acid-based resin composition is degraded, the exterior appearance of the obtained molded article is deteriorated and the strength of the obtained molded article is decreased.

The hydrotalcite compound is preferably surface treated beforehand with such surface treating agents as shown below. The method for surface treating the hydrotalcite compound with surface treating agents is not particularly limited, and may be based on heretofore known methods such as wet methods and dry methods.

Examples of the surface treating agent may include: higher fatty acids; metal salts of higher fatty acids (metal soaps); anionic surfactants; phosphoric acid esters; coupling agents such as silane coupling agents, titanium coupling agents and aluminum coupling agents. From the viewpoint of the compatibility with the polylactic acid resin and the like, higher fatty acids and metal salts of higher fatty acids are preferably used among others.

Specific examples of the surface treating agent may include: higher fatty acids such as stearic acid, oleic acid, erucic acid, palmitic acid and lauric acid; metal salts such as the lithium salts, sodium salts and potassium salts of these higher fatty acids; sulfuric acid ester salts of higher alcohols such as stearyl alcohol and oleyl alcohol; anionic surfactants such as sulfuric acid ester salts of polyethylene glycol ether, amide-bonded sulfuric acid ester salts, ether-bonded sulfonic acid salts, ester-bonded sulfonates, amide-bonded alkylarylsulfonic acid salts, ether-bonded alkylarylsulfonic acid salts; phosphoric acid esters such as mono- or diesters between orthophosphoric acid and alcohols such as oleyl alcohol and stearyl alcohol, or the mixtures of these, the mono- or diesters and the mixtures being any of acid type esters, alkali metal salts or amine salts; silane coupling agents such as vinylethoxysilane, γ-methacryloxypropyltrimethoxysilane, vinyltris(2-methoxyethoxy)silane and γ-aminopropyltrimethoxysilane; titanium coupling agents such as isopropyltriisostearoyl titanate, isopropyltris(dioctyl pyrophosphate)titanate and isopropyltridecylbenzenesulfonyl titanate; and alkali coupling agents such as acetoalkoxyaluminium diisopropylate. Preferable among these surface treating agents are silane coupling agents and stearic acid from the viewpoint of the compatibility with the polylactic acid resin. Accordingly, as the hydrotalcite compound of the present invention, the hydrotalcite compounds surface treated with silane coupling agents or stearic acid are more preferable.

Preferably, a jojoba oil is further contained in the polylactic acid-based resin composition of the present invention.

The jojoba oil has an effect to more improve the dispersibility of the monocarbodiimide compound and the hydrotalcite compound in the resin composition, and hence can more improve the hydrolysis resistance and the durability of the obtained resin composition.

The jojoba oil means the ester collected by expression and distillation from the seeds of natural jojoba (botanical name: Simmondasia Chinensis). This jojoba oil is composed of higher unsaturated fatty acids and higher unsaturated alcohols. Jojoba is an evergreen shrub naturally growing in the arid zones in the South West areas (Arizona State and California State) of the United States and in the northern Mexico (Sonora and Baja Areas), and is a dioecious plant being 60 to 180 cm in tree height, some jojoba trees reaching 3 m. Currently, jojoba is grown in the arid areas in Israel, Australia, Argentina and other countries as well as in the United States and Mexico.

Specific examples of the jojoba oil used in the present invention include a refined jojoba oil obtained by using the oil as prepared by expression and distillation from the seeds as described above and a hydrogenated jojoba oil obtained as a solid by hydrogenating the refined jojoba oil, and additionally, a liquid jojoba alcohol and a cream-like jojoba cream; any of these may be used as long as it is capable of being mixed with the resin.

The boiling point of the jojoba oil is as high as 420° C.; therefore, the jojoba oil persists stably in the resin composition even when mixed, for example, in the melt-kneading of the resin, requiring a high temperature.

The content of the jojoba oil in the polylactic acid-based resin composition is preferably 0.1 to 10 parts by mass, more preferably 0.1 to 4 parts by mass and furthermore preferably 0.1 to 2 parts by mass in relation to 100 parts by mass of the polylactic acid resin or 100 parts by mass of the cross-linked polylactic acid resin. When the content is less than 0.1 parts by mass, the effect of improving the hydrolysis resistance and the durability of the resin composition is poor. On the other hand, when the content exceeds 10 parts by mass, unpreferably a molded article obtained from such a resin composition undergoes bleeding out of the jojoba oil from the molded article to remarkably degrade the physical properties of the molded article as the case may be or to impair the hydrolysis resistance of the molded article as the case may be.

The polylactic acid-based resin composition of the present invention may contain other resin components in addition to the polylactic acid resin as the main component, within a range not impairing the advantageous effects of the present invention. The mixtures obtained by mixing other resin components with the polylactic acid-based resin composition of the present invention can also be used as alloys.

Examples of the resin components other than the polylactic acid resin include: polyamide (nylon), polyester, polyethylene, polypropylene, polystyrene, poly(acrylic acid), poly(acrylic acid ester), poly(methacrylic acid), poly(methacrylic acid ester), polybutadiene, AS (acrylonitrile-styrene) resin, ABS (acrylonitrile-butadiene-styrene) resin, polyethylene terephthalate, polyethylene naphthalate and polycarbonate; and copolymers of these.

In the polylactic acid-based resin composition of the present invention, as long as the advantageous effects of the present invention are not impaired, a heat stabilizer, an antioxidant, a pigment, an antiweathering agent, a flame retardant, a plasticizer, a lubricant, a release agent, an antistatic agent, a filler, a dispersant and others may also be added as additives.

Examples of the heat stabilizer and the antioxidant include sulfur compounds, copper compounds, alkali metal halides and the mixtures of these.

Examples of the filler include inorganic fillers and organic fillers. Examples of the inorganic filler include: talc, zinc carbonate, wollastonite, silica, aluminum oxide, magnesium oxide, calcium silicate, sodium aluminate, calcium aluminate, sodium aluminosilicate, magnesium silicate, glass balloon, carbon black, zinc oxide, antimony trioxide, zeolite, metal fiber, metal whisker, ceramic whisker, potassium titanate, boron nitride, graphite, glass fiber and carbon fiber. Examples of the organic filler include: naturally-occurring polymers such as starch, cellulose fine particles, wood powder, bean curd refuse, rice hull, bran and kenaf; and the modified products of these.

Next, the method for producing the polylactic acid-based resin composition of the present invention is described.

The polylactic acid resin is produced with a heretofore known melt polymerization method, or where necessary, further in combination with a solid phase polymerization method. When the polylactic acid resin is converted into the cross-linked polylactic acid resin, it is preferable to use a method in which, as described above, the polylactic acid resin, the (meth)acrylic acid ester compound, the silane compound in the present invention and the peroxide are melt-kneaded.

Examples of the method for adding a monocarbodiimide compound and a hydrotalcite compound to the polylactic acid resin include: a method for adding the monocarbodiimide compound and the hydrotalcite compound at the time of polymerizing the polylactic acid; a method for melt-kneading the monocarbodiimide compound and the hydrotalcite compound together with the polylactic acid resin; and a method for adding the monocarbodiimide compound and the hydrotalcite compound at the time of molding. From the viewpoint of the operability, preferable among these methods are the method for adding at the time of melt-kneading of the polylactic acid resin and the method for adding at the time of molding. When these additives are added at the time of melt-kneading of the polylactic acid resin or molding, examples of the addition method include: a method for feeding to a common kneader or a common molding machine after these additives have been dry blended beforehand with the polylactic acid resin; and a method in which these additives are added midway through the melt-kneading by using a side feeder. In the case where the jojoba oil is added, when the refined jojoba oil is used, such a jojoba oil is liquid and hence such a jojoba oil is preferably added midway through the kneading by using an apparatus such as a liquid delivery apparatus equipped with a heating unit and a metering unit.

The other additives such as the heat stabilizer are preferably added at the time of melt-kneading or at the time of polymerization.

For melt-kneading, common kneaders such as a single screw extruder, a double screw extruder, a roll kneader and a Brabender kneader can be used. However, from the viewpoint of enhancing the mixing uniformity and the dispersibility, it is preferable to use a double screw extruder.

By using the monocarbodiimide compound and the hydrotalcite compound in combination, the hydrolysis resistance and the durability of the polylactic acid-based resin composition of the present invention are significantly improved to an extent beyond anticipation, so as to overcome the severe drawback of the polylactic acid resin that the polylactic acid resin cannot be used under high temperature and high humidity for a long term, in such a way that the polylactic acid-based resin composition of the present invention can be used under high temperature and high humidity for a long term. Accordingly, when various molded articles are produced by using the polylactic acid-based resin composition of the present invention, such molded articles can also be used in the applications in which conventional polylactic acid resins are in practice insufficient in hydrolysis resistance and durability. For example, the resin composition of the present invention undergoes neither the decrease of strength nor the decrease of the molecular weight due to the deterioration thereof even when used under the harsh conditions of high temperature and high humidity inside automobiles in summertime.

Next, the molded article of the present invention is obtained from the polylactic acid-based resin composition of the present invention, and means various molded articles obtained by molding the polylactic acid-based resin composition of the present invention by heretofore known molding methods such as injection molding, blow molding and extrusion molding.

As the injection molding method, in addition to a common injection molding method, there can be adopted a gas injection molding method, an injection press molding method and the like. In the present invention, an example of the preferable injection molding conditions is such that the cylinder temperature in injection molding is required to be equal to or higher than the melting point (Tm) or the flow initiation temperature of the polylactic acid resin, and preferably falls within a range from 160 to 230° C. and optimally within a range from 170 to 210° C. When the cylinder temperature is too low, molding failure or overload of the apparatus tends to occur due to the degradation of the fluidity of the resin. Conversely, when the cylinder temperature is too high, unpreferably, the polylactic acid resin is decomposed, and the obtained molded article undergoes strength decrease, coloration or the like in a disadvantageous manner.

In the present invention, the die temperature in the injection molding is preferably set at 50° C. or lower for the polylactic acid resin other than the cross-linked polylactic acid resin, and preferably set at 70 to 130° C. for the cross-linked polylactic acid resin. In the case of the polylactic acid resin other than the cross-linked polylactic acid resin, preferably the obtained molded article is subjected, after the injection molding, to a heat treatment (annealing treatment) at 100 to 120° C. for 30 seconds to 60 minutes to promote crystallization and improve the rigidity and the heat resistance of the resin composition.

Examples of the blow molding method include a direct blow method in which molding is directly conducted from material chips, an injection blow molding method in which a preliminary molded article (bottomed parison) is first molded by injection molding and then the preliminary molded article is subjected to blow molding and further a stretching blow molding method. Additionally, either of the following methods can be adopted: a hot parison method in which after molding of a preliminary molded article, successively blow molding is conducted, and a cold parison method in which a preliminary molded article is once cooled and taken out and then heated again to be subjected to blow molding.

As the extrusion molding method, a T-die method, a round die method or the like may be applied. The extrusion molding temperature is required to be equal to or higher than the melting point or the flow initiation temperature of the polylactic acid resin as the material, and preferably falls within a range from 180 to 230° C. and more preferably within a range from 190 to 220° C. When the molding temperature is too low, disadvantageously operation tends to be unstable or overload tends to occur. Conversely, when the molding temperature is too high, unpreferably the polylactic acid resin is decomposed, and the extrusion molded article undergoes strength decrease, coloration or the like in a disadvantageous manner. Extrusion molding enables to produce sheets, pipes and the like.

Specific applications of the sheets or pipes obtained by the extrusion molding method include original sheets for use in deep-draw molding, original sheets for use in batch foaming, cards such as credit cards, sheets laid under writing paper, transparent file holders, straws, agricultural and gardening rigid pipes. Additionally, by further applying deep-draw molding such as vacuum molding, pneumatic molding or vacuum-pneumatic molding to sheets, there can be produced food containers, agricultural and gardening containers, blister pack containers, press-through pack containers and the like.

The deep-draw molding temperature and the heat treatment temperature are preferably (Tg+20)° C. to (Tg+100)° C. When the deep-drawing temperature is lower than (Tg+20)° C., deep-drawing becomes difficult, and conversely, when the deep-drawing temperature exceeds (Tg+100)° C., the polylactic acid resin is decomposed, and thus thickness unevenness is caused and orientation disorder is caused to decrease the impact resistance, as the case may be. The forms of the food containers, agricultural and gardening containers, blister pack containers and press-through pack containers are not particularly limited, but are preferably deep-drawn as deep as 2 mm or more for the purpose of containing food, articles, chemicals and the like. The thickness of each of these containers is not particularly limited, but is preferably 50 μm or more and more preferably 150 to 500 μm from the viewpoint of strength. Specific examples of the food containers include fresh food trays, instant food containers, fast food containers and lunchboxes. Specific examples of the agricultural and gardening containers include seedling raising pots. Specific examples of the blister pack containers include packaging containers for various commercial products such as office articles, toys and dry batteries, as well as food.

Specific examples of the applications of the molded article obtained by such molding methods as described above are shown below.

The molded article of the present invention is particularly suitable for components for use in automobiles through taking advantage of the properties of the molded article that such a molded article is excellent in hydrolysis resistance and durability. Specific examples of the components for use in automobiles include: a bumper member, an instrument panel, a trim, a torque control lever, a safety belt component, a register blade, a washer lever, a window regulator handle, a knob of a window regulator handle, a passing light lever, a sun visor bracket, a console box, a trunk cover, a spare tire cover, a ceiling material, a floor material, an inner plate, a seat material, a door panel, a door board, a steering wheel, a rearview mirror housing, an air duct panel, a window molding fastener, a speed cable liner, a headrest rod holder, various motor housings, various plates and various panels.

Additionally, the molded article of the present invention can also be preferably used in applications requiring hydrolysis resistance and durability, such as the enclosures and various components for office machines, household electric appliances and the like. Specific examples of the office machines include the following components used in a printer, a copying machine or a fax: a front cover, a rear cover in the casing, a paper feed tray, a paper discharge tray, a platen, an interior cover and a toner cartridge. Additionally, the molded article of the present invention can also be preferably used in applications requiring hydrolysis resistance and durability, such as electronic and electric components, medical field, food field, household and office articles, OA machines, building material components and furniture components.

Examples of the other molded articles of the present invention include: eating utensils such as dishes, bowls, pots, chopsticks, spoons, forks and knives; containers for fluids; caps for containers; office supplies such as rules, writing materials, transparent cases and CD cases; daily commodities such as sink-corner strainers, trash containers, basins, toothbrushes, combs and clothes hangers; agricultural and gardening articles such as flower pots and seedling raising pots; various toys such as plastic models. The forms of the containers for fluids are not particularly limited, but are preferably molded as deep as 20 mm or more for the purpose of containing fluids. The thickness of each of these containers for fluids is not particularly limited, but is preferably 0.1 mm or more and more preferably 0.1 to 5 mm from the viewpoint of strength. Specific examples of the containers for fluids include: beverage cups and beverage bottles for dairy products, soft drinks, alcoholic beverages and the like; temporary preservation containers for seasonings such as soy sauce, sauce, mayonnaise, ketchup and edible oil; containers for shampoo, conditioners and the like; containers for cosmetics; and containers for agrichemicals.

The molded article obtained from the resin composition of the present invention may be fibers. The methods for producing such fibers are not particularly limited; however, preferable is a method in which melt spinning is followed by stretching. The melt spinning temperature is preferably 160° C. to 260° C. and more preferably 170° C. to 230° C. When the melt spinning temperature is lower than 160° C., melt extrusion is sometimes difficult. On the other hand, when the melt spinning temperature exceeds 260° C., the decomposition of the resin is remarkable and it is sometimes difficult to obtain high-strength fibers. The melt spun fiber yarns may be stretched at a temperature equal to or higher than Tg so as to have the intended strength and degree of elongation. The fibers obtained by the above-described method are used as clothing fibers and industrial material fibers, and also as short fibers to enable to yield products such as woven knitted products and non-woven fabrics.

Further, the molded article obtained from the resin composition of the present invention may also be a long-fiber non-woven fabric. The method for producing such a fabric is not particularly limited; however, a method can be quoted in which a resin composition is spun into fibers by high-speed spinning, the obtained fibers are deposited and then fabricated into a web, and the web is further processed into a cloth by using a technique such as thermal compression bonding.

### EXAMPLES

Hereinafter, the present invention is described specifically with reference to Examples. Hereinafter, the materials used in Examples and Comparative Examples are described.

[Materials]

(1) Polylactic Acid Resins
PLA1: Trade name: NatureWorks 4032D, manufactured by NatureWorks LLC {L/D ratio (mol %):98.6/1.4, weight average molecular weight (Mw): 170,000, melting point: 170° C., MFI: 2.5 g/10 min (190° C., load: 2.16 kg)}
PLA2: Trade name: NatureWorks 4060D, manufactured by NatureWorks LLC {L/D ratio (mol %):88/12, weight average molecular weight (Mw): 176,000, flow initiation temperature: 150° C. to 190° C., MFI: 11.6 g/10 min (190° C., load: 2.16 kg)}
PLA3: Trade name: S-12, manufactured by Toyota Motor Corp. {L/D ratio (mol % ratio):99.9/0.1, weight average molecular weight (Mw): 135,000, melting point: 176° C., MFI: 6.7 g/10 min (190° C., load: 2.16 kg)}

(2) Carbodiimide Compounds
CD1: N,N′-Di-2,6-diisopropylphenylcarbodiimide (trade name: EN160, manufactured by Matsumoto Yushi-Seiyaku Co., Ltd.)
CD2: N,N′-Di-2,6-diisopropylphenylcarbodiimide (trade name: Stabaxol I, manufactured by Rhein Chemie Corp.)
CD3: Aliphatic polycarbodiimide (trade name: LA-1, manufactured by Nisshinbo Chemical Inc.)
CD4: Polycarbodiimide (trade name: Stabaxol P-100, manufactured by Rhein Chemie Corp.)

(3) Hydrotalcite Compounds
A: Mg₆Al₂(OH)₁₆CO₃.4H₂0 (product surface-treated with a silane coupling agent) [trade name: DHT-4A, manufactured by Kyowa Chemical Industry Co., Ltd.]
B: Product obtained by removing crystallization water (product surface-treated with a silane coupling agent) [trade name: DHT-4A-2, manufactured by Kyowa Chemical Industry Co., Ltd.]
C: Product obtained by removing crystallization water (not surface-treated with a silane coupling agent) [trade name: DHT-4C, manufactured by Kyowa Chemical Industry Co., Ltd.]
D: Baked product, MgO—Al₂O₃ solid solution (product surface-treated with a silane coupling agent) [trade name: Kyowado 2100, manufactured by Kyowa Chemical Industry Co., Ltd.]
E: Mg—Al system (product surface-treated with a silane coupling agent) [trade name: Alkamizer P93-2, manufactured by Kyowa Chemical Industry Co., Ltd.]
F: Mg₄Al₂(OH)₁₂CO₃.3H₂O (product surface-treated with stearic acid) [trade name: STABIACE HT-1, manufactured by Sakai Chemical Industry Co., Ltd.]
G: Mg_{4.5}Al₂(OH)₁₃CO₃.3.5H₂O (product surface-treated with stearic acid) [trade name: STABIACE HT-P, manufactured by Sakai Chemical Industry Co., Ltd.]
H: Mg_{3.5}ZN_{0.5}Al₂(OH)₁₂CO₃.3H₂O (product surface-treated with stearic acid) [trade name: STABIACE HT-7, manufactured by Sakai Chemical Industry Co., Ltd.]

(4) Inorganic Fillers
I: Synthetic smectite (trade name: Lucentite SWF, manufactured by Co-op Chemical Co., Ltd.)
J: Synthetic smectite (trade name: Lucentite SWN, manufactured by Co-op Chemical Co., Ltd.)
K: Calcium carbonate (trade name: CC, manufactured by Shiraishi Kogyo Kaisha, Ltd.)
L: Calcium carbonate (trade name: DD, manufactured by Shiraishi Kogyo Kaisha, Ltd.)

(5) Peroxide
PBD: Di-t-butyl peroxide (trade name: Perbutyl D, manufactured by NOF Corp.)

(6) (Meth)acrylic Acid Ester Compound
PDE: Ethyleneglycol dimethacrylate (trade name: Blenmer PDE-50, manufactured by NOF Corp.)

(7) Silane Compound
KBM: Vinyltrimethoxysilane (trade name: KBM-1003, manufactured by Shin-Etsu Chemical Co., Ltd.)

(8) Plasticizer
M-1: Medium chain fatty acid triglyceride (trade name: Actor M-1, manufactured by Riken Vitamin Co., Ltd.)

(9) Jojoba Oil
Refined Jojoba Oil (trade name: Refined Jojoba Oil, manufactured by Koei Kogyo Co., Ltd.)

[Evaluation Methods]

Hereinafter, the measurement methods used for the evaluation of Examples and Comparative Examples are described.

(1) L/D Ratio (mol %) of Polylactic Acid Resin

An obtained resin composition was weighed in an amount of 0.3 g, added to 6 mL of a 1N potassium hydroxide/methanol solution and sufficiently stirred at 65° C. To the resulting solution, 450 μL of sulfuric acid was added and stirred at 65° C. to decompose the polylactic acid; 5 mL of the resulting solution was measured off as a sample. With the sample, 3 mL of purified water and 13 mL of methylene chloride were mixed and the resulting mixture was shaken up. The mixture was allowed to stand for separation, and then about 1.5 mL of the lower organic layer was sampled, filtered with a disc filter for HPLC having a pore size of 0.45 μm, and then subjected to a gas chromatographic measurement with the HP-6890 Series GC system manufactured by Hewlett-Packard Co. The proportion (%) of the peak area of methyl D-lactate in the total peak area of the methyl ester lactate was derived, and the L/D ratio was obtained from this proportion.

(2) Flexural Rupture Strength

By using an obtained resin composition, an injection molding was performed under the below-shown injection molding conditions to obtain a 5 inches×½ inch×⅛ inch molded specimen.

In the cases (Examples 1 to 26 and Comparative Examples 1 to 20) of the resin compositions each using a polylactic acid resin containing no cross-linking agent, molded specimens were obtained under the injection molding conditions 1.

On the other hand, in the cases (Examples 27 to 39 and Comparative Examples 21 to 34) of the resin compositions each using a cross-linked polylactic acid resin containing a cross-linking agent, molded specimens were obtained under the injection molding conditions 2. Next, by applying a load to such a molded specimen at a deformation rate of 1 mm/min according to the ASTM-790, the flexural rupture strength (initial flexural rupture strength) of the molded specimen was measured.

[Injection Molding Conditions 1]

Apparatus: An injection molding machine (trade name: Model IS-80G, manufactured by Toshiba Machine Co., Ltd.)

Cylinder temperature: 170 to 190° C.

Die temperature: 15° C.

Retention time: 20 seconds

Die standard: ASTM standard, a die for the ⅛-inch three-point bend specimen

[Injection Molding Conditions 2]

Apparatus: An injection molding machine (trade name: Model IS-80G, manufactured by Toshiba Machine Co., Ltd.)

Cylinder temperature: 170 to 190° C.

Die temperature: 100° C.

Retention time: 60 seconds

Die standard: ASTM standard, a die for the ⅛-inch three-point bend specimen

(3) Hydrolysis Resistance

By using a thermo-hygrostat (trade name: Model IG400, manufactured by Yamato Science Co., Ltd.), the molded specimens obtained in the above-described (2) were subjected to a humidity-heat treatment by storing the molded specimens in an environment of a temperature of 70° C. and a relative humidity of 95%. The storage time (humidity-heat treatment time) was set at 500 hours, 1000 hours, 1500 hours and 2000 hours. The molded specimens subjected to the humidity-heat treatment respectively for these treatment times were collected, and the flexural rupture strength of each of the molded specimens was measured in the same manner as in the above-described (2). By using the initial flexural rupture strength measured in the above-described (2), on the basis of the following formula, the flexural strength retention rate was calculated.

Flexural strength retention rate (%)=(flexural rupture strength after the humidity−heat treatment)/(initial flexural rupture strength)×100

(4) Exterior Appearance Evaluation

The surface of each of the molded specimens subjected to the above-described (3) humidity-heat treatment, respectively for 500, 1000, 1500 and 2000 hours was visually observed, and compared with the exterior appearance of the molded specimen before the humidity-heat treatment, and was evaluated with respect to the exterior appearance on the basis of the following standards.

E (Excellent): Absolutely no change is observed.

G (Good): The surface is slightly whitened.

A (Average): The surface is changed in quality to be powdery.

P (Poor): The molded specimen undergoes cracking, bleeding out or deformation.

(5) Deflection Temperature Under Load (DTUL) (° C.)

By using each of the molded specimens obtained in the same manner as in the above-described (2), the deflection temperature under load was measured according to ISO 75-1 under a load of 0.45 MPa.

### Example 1

First, 100 parts by mass of PLA1 as a polylactic acid resin, 4 parts by mass of CD1 as a monocarbodiimide compound and 0.5 part by mass of A as a hydrotalcite compound were dry blended together, and then melt-kneaded with a double screw extruder (trade name: Model PCM-30, manufactured by Ikegai Corp.) under the conditions of a temperature of 190° C. and a screw rotation number of 150 rpm. After performing the melt-kneading, strands were extruded from a die with three holes of 0.4 mm in diameter, the strands were cut into a pellet shape, and subjected to a drying treatment at 60° C. for 48 hours with a vacuum dryer (trade name: Vacuum Dryer DP83, manufactured by Yamato Science Co., Ltd.), and thus pellets (a polylactic acid-based resin composition) were obtained.

### Examples 2 to 8

In each of Examples 2 to 8, pellets of a polylactic acid-based resin composition were obtained in the same manner as in Example 1 except that as shown in Table 1, as the hydrotalcite compound, B, C, D, E, F, G and H were used in place of A in Examples 2 to 8, respectively.

### Example 9

Pellets of a polylactic acid-based resin composition were obtained in the same manner as in Example 1 except that CD2 was used as the monocarbodiimide compound.

### Example 10

Pellets of a polylactic acid-based resin composition were obtained in the same manner as in Example 1 except that PLA2 was used as the polylactic acid resin.

### Example 11

Pellets of a polylactic acid-based resin composition were obtained in the same manner as in Example 9 except that PLA2 was used as the polylactic acid resin.

### Example 12

Pellets of a polylactic acid-based resin composition were obtained in the same manner as in Example 1 except that the mixing amount of the monocarbodiimide compound CD1 was altered to 2 parts by mass.

### Example 13

Pellets of a polylactic acid-based resin composition were obtained in the same manner as in Example 1 except that the mixing amount of the monocarbodiimide compound CD1 was altered to 8 parts by mass.

### Example 14

Pellets of a polylactic acid-based resin composition were obtained in the same manner as in Example 1 except that the mixing amount of the hydrotalcite compound A was set at 1.0 part by mass.

### Example 15

Pellets of a polylactic acid-based resin composition were obtained in the same manner as in Example 1 except that the mixing amount of the hydrotalcite compound A was set at 1.5 parts by mass.

### Example 16

Pellets of a polylactic acid-based resin composition were obtained in the same manner as in Example 1 except that the mixing amount of the monocarbodiimide compound CD1 was altered to 0.5 part by mass.

### Example 17

Pellets of a polylactic acid-based resin composition were obtained in the same manner as in Example 1 except that 2 parts by mass of the refined jojoba oil was mixed.

### Example 18

Pellets of a polylactic acid-based resin composition were obtained in the same manner as in Example 1 except that 0.1 part by mass of the refined jojoba oil was mixed.

### Example 19

Pellets of a polylactic acid-based resin composition were obtained in the same manner as in Example 1 except that 1 part by mass of the refined jojoba oil was mixed.

### Example 20

Pellets of a polylactic acid-based resin composition were obtained in the same manner as in Example 1 except that 4 parts by mass of the refined jojoba oil was mixed.

### Example 21

Pellets of a polylactic acid-based resin composition were obtained in the same manner as in Example 1 except that 100 parts by mass of PLA3 was used as the polylactic acid resin.

### Example 22

Pellets of a polylactic acid-based resin composition were obtained in the same manner as in Example 21 except that 2 parts by mass of the refined jojoba oil was mixed.

### Examples 23 and 24

In each of Examples 23 and 24, pellets of a polylactic acid-based resin composition were obtained in the same manner as in Example 22 except that as shown in Table 4, as the hydrotalcite compound, B and C were used in place of A in Examples 23 and 24, respectively.

### Example 25

The pellets of the polylactic acid-based resin composition obtained in Example 1 were used, and an injection molded specimen was obtained in the flexural rupture strength measurement in the above-described (2). The obtained molded specimen was heat treated in an oven at 120° C. for 30 minutes to be subjected to an annealing treatment.

### Example 26

The pellets of the polylactic acid-based resin composition obtained in Example 22 were used, and an injection molded specimen was obtained in the flexural rupture strength measurement in the above-described (2). The obtained molded specimen was heat treated in an oven at 120° C. for 30 minutes to be subjected to an annealing treatment.

The compositions, the values of the properties and the evaluation results of the polylactic acid-based resin compositions obtained in Examples 1 to 8 are shown in Table 1. The compositions, the values of the properties and the evaluation results of the polylactic acid-based resin compositions obtained in Examples 9 to 13 are shown in Table 2. The compositions, the values of the properties and the evaluation results of the polylactic acid-based resin compositions obtained in Examples 14 to 20 are shown in Table 3. The compositions, the values of the properties and the evaluation results of the polylactic acid-based resin compositions obtained in Examples 21 to 24, and the values of the properties and the evaluation results of the molded specimens obtained in Examples 25 and 26 are shown in Table 4.

TABLE 1

| | | | | | | | | | | | | | | Hydrolysis resistance | | | | | |
|---|---|---|---|---|---|---|---|---|---|---|---|---|---|---|---|---|---|---|---|
| | | | | | | | | | | | | | | Upper row: Flexural rupture strength after | | | | | Heat |
| | Composition (parts by mass) | | | | | | | | | | | | | humidity-heat test (MPa) | | | | | resistance |
| | | | Mono- | | | | | | | | | | | Middle row: Flexural strength retention rate (%) | | | | | Deflection |
| | Polylactic | | carbodiimide | | | | | | | | | | Refined | Lower row: Exterior appearance evaluation | | | | | temperature |
| Exam- | acids | | compounds | | Hydrotalcite compounds | | | | | | | | jojoba | After | After | After | After | After | under load |
| ple | PLA1 | PLA2 | CD1 | CD2 | A | B | C | D | E | F | G | H | oil | 0 h | 500 h | 1000 h | 1500 h | 2000 h | (° C.) |
| 1 | 100 | — | 4 | — | | — | — | — | — | — | — | — | — | 103 | 101 | 97 | 87 | 80 | 57 |
| | | | | | 0.5 | | | | | | | | | 100% | 98% | 94% | 84% | 78% | |
| | | | | | | | | | | | | | | E | E | E | G | G | |
| 2 | 100 | — | 4 | — | — | 0.5 | — | — | — | — | — | — | — | 102 | 98 | 95 | 87 | 79 | 56 |
| | | | | | | | | | | | | | | 100% | 96% | 93% | 85% | 77% | |
| | | | | | | | | | | | | | | E | E | E | G | G | |
| 3 | 100 | — | 4 | — | — | — | 0.5 | — | — | — | — | — | — | 108 | 102 | 93 | 90 | 81 | 57 |
| | | | | | | | | | | | | | | 100% | 94% | 86% | 83% | 75% | |
| | | | | | | | | | | | | | | E | E | E | G | G | |
| 4 | 100 | — | 4 | — | — | — | — | 0.5 | — | — | — | — | — | 102 | 99 | 88 | 83 | 75 | 58 |
| | | | | | | | | | | | | | | 100% | 97% | 86% | 81% | 74% | |
| | | | | | | | | | | | | | | E | E | E | G | G | |
| 5 | 100 | — | 4 | — | — | — | — | — | 0.5 | — | — | — | — | 99 | 93 | 91 | 84 | 76 | 56 |
| | | | | | | | | | | | | | | 100% | 94% | 92% | 85% | 77% | |
| | | | | | | | | | | | | | | E | E | E | G | G | |
| 6 | 100 | — | 4 | — | — | — | — | — | — | 0.5 | — | — | — | 99 | 89 | 8 5 | 80 | 73 | 58 |
| | | | | | | | | | | | | | | 100% | 90% | 86% | 81% | 74% | |
| | | | | | | | | | | | | | | E | E | E | G | G | |
| 7 | 100 | — | 4 | — | — | — | — | — | — | — | 0.5 | — | — | 100 | 92 | 87 | 83 | 75 | 57 |
| | | | | | | | | | | | | | | 100% | 92% | 87% | 83% | 75% | |
| | | | | | | | | | | | | | | E | E | E | G | G | |
| 8 | 100 | — | 4 | — | — | — | — | — | — | — | — | 0.5 | — | 102 | 92 | 88 | 84 | 72 | 57 |
| | | | | | | | | | | | | | | 100% | 90% | 86% | 82% | 71% | |
| | | | | | | | | | | | | | | E | E | E | G | G | |

—: Indicating no mixing.

TABLE 2

| | | | | | | | | | | | | | | Hydrolysis resistance | | | | | |
|---|---|---|---|---|---|---|---|---|---|---|---|---|---|---|---|---|---|---|---|
| | | | | | | | | | | | | | | Upper row: Flexural rupture strength after | | | | | Heat |
| | Composition (parts by mass) | | | | | | | | | | | | | humidity-heat test (MPa) | | | | | resistance |
| | | | Mono- | | | | | | | | | | | Middle row: Flexural strength retention rate (%) | | | | | Deflection |
| | Polylactic | | carbodiimide | | | | | | | | | | Refined | Lower row: Exterior appearance evaluation | | | | | temperature |
| Exam- | acids | | compounds | | Hydrotalcite compounds | | | | | | | | jojoba | After | After | After | After | After | under load |
| ple | PLA1 | PLA2 | CD1 | CD2 | A | B | C | D | E | F | G | H | oil | 0 h | 500 h | 1000 h | 1500 h | 2000 h | (° C.) |
| 9 | 100 | — | — | 4 | 0.5 | — | — | — | — | — | — | — | — | 99 | 92 | 85 | 82 | 74 | 56 |
| | | | | | | | | | | | | | | 100% | 93% | 86% | 83% | 75% | |
| | | | | | | | | | | | | | | E | E | E | G | G | |
| 10 | — | 100 | 4 | — | 0.5 | — | — | — | — | — | — | — | — | 98 | 92 | 84 | 80 | 72 | 55 |
| | | | | | | | | | | | | | | 100% | 94% | 86% | 82% | 73% | |
| | | | | | | | | | | | | | | E | E | E | G | G | |
| 11 | — | 100 | — | 4 | 0.5 | — | — | — | — | — | — | — | — | 97 | 91 | 83 | 81 | 68 | 54 |
| | | | | | | | | | | | | | | 100% | 94% | 86% | 84% | 70% | |
| | | | | | | | | | | | | | | E | E | E | G | G | |
| 12 | 100 | — | 2 | — | 0.5 | — | — | — | — | — | — | — | — | 110 | 98 | 92 | 90 | 77 | 59 |
| | | | | | | | | | | | | | | 100% | 89% | 84% | 82% | 70% | |
| | | | | | | | | | | | | | | E | E | E | G | G | |
| 13 | 100 | — | 8 | — | 0.5 | — | — | — | — | — | — | — | — | 82 | 80 | 79 | 77 | 69 | 51 |
| | | | | | | | | | | | | | | 100% | 98% | 96% | 94% | 84% | |
| | | | | | | | | | | | | | | E | E | E | G | A | |

—: Indicating no mixing.

TABLE 3

| | | | | | | | | | Hydrolysis resistance | | | | | |
|---|---|---|---|---|---|---|---|---|---|---|---|---|---|---|
| | | | | | | | | | Upper row: Flexural rupture strength after | | | | | Heat |
| | | | | | | | | | humidity-heat test (MPa) | | | | | resistance |
| | Composition (parts by mass) | | | | | | | | Middle row: Flexural strength retention rate (%) | | | | | Deflection |
| | Polylactic | | Monocarbodiimide | | Hydrotalcite | | | Refined | Lower row: Exterior appearance evaluation | | | | | temperature |
| Exam- | acids | | compounds | | compounds | | | jojoba | After | After | After | After | After | under load |
| ple | PLA1 | PLA3 | CD1 | CD2 | A | B | C | oil | 0 h | 500 h | 1000 h | 1500 h | 2000 h | (° C.) |
| 14 | 100 | — | 4 | — | 1.0 | — | — | — | 105 | 99 | 91 | 88 | 77 | 58 |
| | | | | | | | | | 100% | 94% | 87% | 84% | 73% | |
| | | | | | | | | | E | E | E | G | G | |
| 15 | 100 | — | 4 | — | 1.5 | — | — | — | 110 | 99 | 95 | 93 | 81 | 59 |
| | | | | | | | | | 100% | 90% | 86% | 85% | 74% | |
| | | | | | | | | | E | E | E | G | G | |
| 16 | 100 | — | 0.5 | — | 0.5 | — | — | — | 118 | 95 | 85 | 72 | 55 | 58 |
| | | | | | | | | | 100% | 81% | 72% | 61% | 47% | |
| | | | | | | | | | E | G | G | G | A | |
| 17 | 100 | — | 4 | — | 0.5 | — | — | 2 | 85 | 84 | 82 | 73 | 70 | 52 |
| | | | | | | | | | 100% | 99% | 96% | 86% | 82% | |
| | | | | | | | | | E | E | E | E | G | |
| 18 | 100 | — | 4 | — | 0.5 | — | — | 0.1 | 100 | 100 | 92 | 84 | 80 | 55 |
| | | | | | | | | | 100% | 100% | 92% | 84% | 80% | |
| | | | | | | | | | E | E | E | G | G | |
| 19 | 100 | — | 4 | — | 0.5 | — | — | 1 | 92 | 91 | 87 | 78 | 74 | 52 |
| | | | | | | | | | 100% | 99% | 95% | 85% | 80% | |
| | | | | | | | | | E | E | E | G | G | |
| 20 | 100 | — | 4 | — | 0.5 | — | — | 4 | 72 | 71 | 69 | 63 | 61 | 51 |
| | | | | | | | | | 100% | 99% | 96% | 88% | 85% | |
| | | | | | | | | | E | E | E | G | G | |

—: Indicating no mixing.

TABLE 4

| | | | | | | | | | Hydrolysis resistance | | | | | |
|---|---|---|---|---|---|---|---|---|---|---|---|---|---|---|
| | | | | | | | | | Upper row: Flexural rupture strength after | | | | | Heat |
| | | | | | | | | | humidity-heat test (MPa) | | | | | resistance |
| | Composition (parts by mass) | | | | | | | | Middle row: Flexural strength retention rate (%) | | | | | Deflection |
| | Polylactic | | Monocarbodiimide | | Hydrotalcite | | | Refined | Lower row: Exterior appearance evaluation | | | | | temperature |
| Exam- | acids | | compounds | | compounds | | | jojoba | After | After | After | After | After | under load |
| ple | PLA1 | PLA3 | CD1 | CD2 | A | B | C | oil | 0 h | 500 h | 1000 h | 1500 h | 2000 h | (° C.) |
| 21 | — | 100 | 4 | — | 0.5 | — | — | — | 85 | 84 | 82 | 74 | 69 | 63 |
| | | | | | | | | | 100% | 99% | 96% | 87% | 81% | |
| | | | | | | | | | E | E | E | E | G | |
| 22 | — | 100 | 4 | — | 0.5 | — | — | 2 | 77 | 75 | 77 | 67 | 66 | 61 |
| | | | | | | | | | 100% | 97% | 100% | 87% | 86% | |
| | | | | | | | | | E | E | E | E | G | |
| 23 | — | 100 | 4 | — | — | 0.5 | — | 2 | 76 | 77 | 73 | 65 | 61 | 61 |
| | | | | | | | | | 100% | 101% | 96% | 86% | 80% | |
| | | | | | | | | | E | E | E | E | G | |
| 24 | — | 100 | 4 | — | — | — | 0.5 | 2 | 74 | 72 | 68 | 64 | 59 | 60 |
| | | | | | | | | | 100% | 97% | 92% | 86% | 80% | |
| | | | | | | | | | E | E | E | E | G | |
| 25 | 100 | — | 4 | — | 0.5 | — | — | — | 125 | 124 | 124 | 123 | 112 | 118 |
| | | | | | | | | | 100% | 99% | 99% | 98% | 90% | |
| | | | | | | | | | E | E | E | E | E | |
| 26 | — | 100 | 4 | — | 0.5 | — | — | 2 | 119 | 119 | 118 | 118 | 113 | 128 |
| | | | | | | | | | 100% | 100% | 99% | 99% | 95% | |
| | | | | | | | | | E | E | E | E | E | |

—: Indicating no mixing.

### Comparative Example 1

Pellets of a polylactic acid-based resin composition were obtained in the same manner as in Example 1 except that no hydrotalcite compound was used.

### Comparative Example 2

Pellets of a polylactic acid-based resin composition were obtained in the same manner as in Comparative Example 1 except that the mixing amount of the monocarbodiimide compound CD1 was altered to 6 parts by mass.

### Comparative Example 3

Pellets of a polylactic acid-based resin composition were obtained in the same manner as in Comparative Example 1 except that the mixing amount of the monocarbodiimide compound CD1 was altered to 8 parts by mass.

### Comparative Example 4

Pellets of a polylactic acid-based resin composition were obtained in the same manner as in Example 17 except that no hydrotalcite compound was used.

### Comparative Example 5

Pellets of a polylactic acid-based resin composition were obtained in the same manner as in Example 1 except that no monocarbodiimide compound was used.

### Comparative Example 6

Pellets of a polylactic acid-based resin composition were obtained in the same manner as in Example 1 except that the mixing amount of the hydrotalcite compound A was altered to 0.03 part by mass.

### Comparative Example 7

Pellets of a polylactic acid-based resin composition were obtained in the same manner as in Example 1 except that the mixing amount of the hydrotalcite compound A was altered to 3 parts by mass.

### Comparative Example 8

Pellets of a polylactic acid-based resin composition were obtained in the same manner as in Example 14 except that the mixing amount of the monocarbodiimide compound CD1 was altered to 0.08 part by mass.

### Comparative Example 9

Pellets of a polylactic acid-based resin composition were obtained in the same manner as in Example 1 except that the mixing amount of the monocarbodiimide compound CD1 was altered to 12 parts by mass.

### Comparative Examples 10 and 11

In each of Comparative Examples 10 and 11, pellets of a polylactic acid-based resin composition were obtained in the same manner as in Example 1 except that as shown in Table 6, the monocarbodiimide compound CD1 was replaced with the polycarbodiimide compounds CD3 and CD4 in Comparative Examples 10 and 11, respectively.

### Comparative Example 12

Pellets of a polylactic acid-based resin composition were obtained in the same manner as in Example 17 except that the monocarbodiimide compound CD1 was replaced with the polycarbodiimide compound CD3.

### Comparative Examples 13 to 16

In each of Comparative Examples 13 to 16, pellets of a polylactic acid-based resin composition were obtained in the same manner as in Example 1 except that as shown in Table 7, the hydrotalcite compound A was replaced with the inorganic fillers I, J, K and L in Examples 13 to 16, respectively.

### Comparative Example 17

Pellets of a polylactic acid-based resin composition were obtained in the same manner as in Example 21 except that the hydrotalcite compound A was not used.

### Comparative Example 18

Pellets of a polylactic acid-based resin composition were obtained in the same manner as in Comparative Example 17 except that the mixing amount of the monocarbodiimide compound CD1 was altered to 6 parts by mass.

### Comparative Example 19

Pellets of a polylactic acid-based resin composition were obtained in the same manner as in Comparative Example 17 except that the mixing amount of the monocarbodiimide compound CD1 was altered to 8 parts by mass.

### Comparative Example 20

Pellets of a polylactic acid-based resin composition were obtained in the same manner as in Example 22 except that the hydrotalcite compound A was not used.

The compositions, the values of the properties and the evaluation results of the polylactic acid-based resin compositions obtained in Comparative Examples 1 to 4 are shown in Table 5. The compositions, the values of the properties and the evaluation results of the polylactic acid-based resin compositions obtained in Comparative Examples 5 to 11 are shown in Table 6. The compositions, the values of the properties and the evaluation results of the polylactic acid-based resin compositions obtained in Comparative Examples 12 to 20 are shown in Table 7.

TABLE 5

| | | | | | | | | | | | Hydrolysis resistance | | | | | |
|---|---|---|---|---|---|---|---|---|---|---|---|---|---|---|---|---|
| | | | | | | | | | | | Upper row: Flexural rupture strength after | | | | | Heat |
| | Composition (parts by mass) | | | | | | | | | | humidity-heat test (MPa) | | | | | resistance |
| | Polylac- | | | | Hydro- | | | | | | Middle row: Flexural strength retention rate (%) | | | | | Deflection |
| Compar- | tic | Carbodiimide | | | talcite | Inorganic | | | | Refined | Lower row: Exterior appearance evaluation | | | | | temperature |
| ative | acids | compounds | | | compounds | fillers | | | | jojoba | After | After | After | After | After | under load |
| Example | PLA1 | CD1 | CD3 | CD4 | A | I | J | K | L | oil | 0 h | 500 h | 1000 h | 1500 h | 2000 h | (° C.) |
| 1 | 100 | 4 | — | — | — | — | — | — | — | — | 110 | 95 | 91 | 72 | 48 | 55 |
| | | | | | | | | | | | 100% | 86% | 83% | 65% | 44% | |
| | | | | | | | | | | | E | E | G | A | P | |
| 2 | 100 | 6 | — | — | — | — | — | — | — | — | 92 | 90 | 78 | 72 | 62 | 53 |
| | | | | | | | | | | | 100% | 98% | 85% | 78% | 67% | |
| | | | | | | | | | | | E | E | G | A | P | |
| 3 | 100 | 8 | — | — | — | — | — | — | — | — | 82 | 80 | 71 | 71 | 69 | 51 |
| | | | | | | | | | | | 100% | 98% | 87% | 87% | 84% | |
| | | | | | | | | | | | E | E | G | A | P | |
| 4 | 100 | 4 | — | — | — | — | — | — | — | 2 | 92 | 90 | 75 | 72 | 58 | 52 |
| | | | | | | | | | | | 100% | 98% | 82% | 78% | 63% | |
| | | | | | | | | | | | E | E | G | A | P | |

—: Indicating no mixing.
/: Indicating strength too low to measure.

TABLE 6

| | | | | | | | | | | | Hydrolysis resistance | | | | | |
|---|---|---|---|---|---|---|---|---|---|---|---|---|---|---|---|---|
| | | | | | | | | | | | Upper row: Flexural rupture strength after | | | | | Heat |
| | Composition (parts by mass) | | | | | | | | | | humidity-heat test (MPa) | | | | | resistance |
| | Polylac- | | | | Hydro- | | | | | | Middle row: Flexural strength retention rate (%) | | | | | Deflection |
| Compar- | tic | Carbodiimide | | | talcite | Inorganic | | | | Refined | Lower row: Exterior appearance evaluation | | | | | temperature |
| ative | acids | compounds | | | compounds | fillers | | | | jojoba | After | After | After | After | After | under load |
| Example | PLA1 | CD1 | CD3 | CD4 | A | I | J | K | L | oil | 0 h | 500 h | 1000 h | 1500 h | 2000 h | (° C.) |
| 5 | 100 | — | — | — | 0.5 | — | — | — | — | — | 108 | / | / | / | / | 58 |
| | | | | | | | | | | | 100% | / | / | / | / | |
| | | | | | | | | | | | E | / | / | / | / | |
| 6 | 100 | 4 | — | — | 0.03 | — | — | — | — | — | 98 | 93 | 82 | 65 | 39 | 56 |
| | | | | | | | | | | | 100% | 95% | 84% | 66% | 40% | |
| | | | | | | | | | | | E | E | G | A | P | |
| 7 | 100 | 4 | — | — | 3 | — | — | — | — | — | 95 | 76 | 54 | / | / | 57 |
| | | | | | | | | | | | 100% | 80% | 57% | / | / | |
| | | | | | | | | | | | E | G | P | / | / | |
| 8 | 100 | 0.08 | — | — | 1.0 | — | — | — | — | — | 110 | 62 | / | / | / | 59 |
| | | | | | | | | | | | 100% | 56% | / | / | / | |
| | | | | | | | | | | | E | P | / | / | / | |
| 9 | 100 | 12 | — | — | 0.5 | — | — | — | — | — | 72 | 70 | 67 | 63 | 59 | 51 |
| | | | | | | | | | | | 100% | 97% | 93% | 88% | 82% | |
| | | | | | | | | | | | E | E | A | P | P | |
| 10 | 100 | — | 4 | — | 0.5 | — | — | — | — | — | 112 | 36 | / | / | / | 57 |
| | | | | | | | | | | | 100% | 32% | / | / | / | |
| | | | | | | | | | | | E | P | / | / | / | |
| 11 | 100 | — | — | 4 | 0.5 | — | — | — | — | — | 110 | 40 | / | / | / | 56 |
| | | | | | | | | | | | 100% | 36% | / | / | / | |
| | | | | | | | | | | | E | P | / | / | / | |

—: Indicating no mixing.
/: Indicating strength too low to measure.

TABLE 7

| | | | | | | | | | | | Hydrolysis resistance | | | | | |
|---|---|---|---|---|---|---|---|---|---|---|---|---|---|---|---|---|
| | | | | | | | | | | | Upper row: Flexural rupture strength after | | | | | Heat |
| | | | | | | | | | | | humidity-heat test (MPa) | | | | | resistance |
| | Composition (parts by mass) | | | | | | | | | | Middle row: Flexural strength retention rate (%) | | | | | Deflection |
| Compar- | Polylactic | | Carbodiimide | | Hydrotalcite | | | | | Refined | Lower row: Exterior appearance evaluation | | | | | temperature |
| ative | acids | | compounds | | compounds | Inorganic fillers | | | | jojoba | After | After | After | After | After | under load |
| Example | PLA1 | PLA3 | CD1 | CD3 | A | I | J | K | L | oil | 0 h | 500 h | 1000 h | 1500 h | 2000 h | (° C.) |
| 12 | 100 | — | — | 4 | 0.5 | — | — | — | — | 2 | 105 | 55 | / | / | / | 52 |
| | | | | | | | | | | | 100% | 52% | / | / | / | |
| | | | | | | | | | | | E | P | / | / | / | |
| 13 | 100 | — | 4 | — | — | 0.5 | — | — | — | — | 103 | 94 | 88 | 52 | / | 55 |
| | | | | | | | | | | | 100% | 91% | 85% | 50% | / | |
| | | | | | | | | | | | E | G | A | A | / | |
| 14 | 100 | — | 4 | — | — | — | 0.5 | — | — | — | 102 | 99 | 90 | 42 | / | 56 |
| | | | | | | | | | | | 100% | 97% | 88% | 41% | / | |
| | | | | | | | | | | | E | G | A | A | / | |
| 15 | 100 | — | 4 | — | — | — | — | 0.5 | — | — | 105 | 94 | 84 | 67 | / | 55 |
| | | | | | | | | | | | 100% | 90% | 80% | 64% | / | |
| | | | | | | | | | | | E | G | A | A | / | |
| 16 | 100 | — | 4 | — | — | — | — | — | 0.5 | — | 100 | 88 | 82 | 65 | / | 54 |
| | | | | | | | | | | | 100% | 88% | 82% | 65% | / | |
| | | | | | | | | | | | E | G | A | A | / | |
| 17 | — | 100 | 4 | — | — | — | — | — | — | — | 83 | 77 | 71 | 66 | 53 | 62 |
| | | | | | | | | | | | 100% | 93% | 86% | 80% | 64% | |
| | | | | | | | | | | | E | E | E | G | A | |
| 18 | — | 100 | 6 | — | — | — | — | — | — | — | 79 | 72 | 69 | 65 | 59 | 59 |
| | | | | | | | | | | | 100% | 91% | 87% | 82% | 75% | |
| | | | | | | | | | | | E | E | E | G | A | |
| 19 | — | 100 | 8 | — | — | — | — | — | — | — | 72 | 67 | 65 | 64 | 62 | 58 |
| | | | | | | | | | | | 100% | 93% | 90% | 89% | 86% | |
| | | | | | | | | | | | E | E | E | G | A | |
| 20 | — | 100 | 4 | — | — | — | — | — | — | 2 | 81 | 77 | 70 | 68 | 59 | 59 |
| | | | | | | | | | | | 100% | 95% | 86% | 84% | 73% | |
| | | | | | | | | | | | E | E | E | G | A | |

—: Indicating no mixing.
/: Indicating strength too low to measure.

As can be seen from Tables 1 to 7, the resin compositions of Examples 1 to 24 were each a composition in which a polylactic acid resin, a monocarbodiimide compound and a hydrotalcite compound were mixed in specific proportions, and hence the obtained molded articles from the resin compositions were high in the initial flexural rupture strength, and even after an elapsed time of 2000 hours under the conditions of 70° C. and a relative humidity of 95%, high in the flexural strength retention rate and also excellent in hydrolysis resistance. The aforementioned molded articles were able to retain satisfactory exterior appearance for a longer term than the molded articles of Comparative Examples, and were also excellent in durability.

The resin compositions of Examples 17 to 20 were the compositions in each of which the jojoba oil was mixed in an appropriate amount, and as compared to Examples 1 to 8, the flexural strength retention rate, after an elapsed time of 2000 hours, of each of the obtained molded articles was higher and the hydrolysis resistance, after an elapsed time of 2000 hours, of each of the obtained molded articles was furthermore excellent.

The resin compositions of Examples 21 to 24 were the composition in each of which the proportion of poly(D-lactic acid) in the polylactic acid resin was as low as 0.1 mol %, and hence were improved in crystallinity, and as compared to Examples 1 to 3, the obtained molded articles were more excellent in heat resistance, and the flexural strength retention rate, after an elapsed time of 2000 hours, of each of the obtained molded articles was higher and the hydrolysis resistance, after an elapsed time of 2000 hours, of each of the obtained molded articles was furthermore excellent.

In Examples 25 and 26, shown are the evaluations of the hydrolysis resistance and the heat resistance of each of the molded articles obtained by applying an annealing treatment to the molded articles obtained from the resin compositions of Examples 1 and 22, respectively; it can be seen that the annealing treatment promotes the crystallinity, and improves the hydrolysis resistance, durability and heat resistance.

The resin compositions of Comparative Examples 1 and 2 were poorer in hydrolysis resistance and durability than the resin compositions of any Examples in each of which a monocarbodiimide compound was mixed in an amount of 4 parts by mass because no hydrotalcite compound was mixed in the resin compositions of Comparative Examples 1 and 2.

The resin composition of Comparative Example 3 was poorer in hydrolysis resistance and durability as compared to Example 13 in which 8 parts by mass of a monocarbodiimide compound was mixed because no hydrotalcite compound was mixed in the resin composition of Comparative Example 3.

The resin composition of Comparative Example 4 was poorer in hydrolysis resistance and durability than the resin compositions of any Examples in each of which a monocarbodiimide compound was mixed in an amount of 4 parts by mass even when the jojoba oil was used because no hydrotalcite compound was mixed in the resin composition of Comparative Example 4.

The resin composition of Comparative Example 5 was significantly poorer in hydrolysis resistance and durability than any Examples because no monocarbodiimide compound was mixed in the resin composition of Comparative Example 5.

The resin composition of Comparative Example 6 was poorer in hydrolysis resistance and durability as compared to Example 1 because the mixing amount of the hydrotalcite compound in the resin composition of Comparative Example 6 was too small.

The resin composition of Comparative Example 7 was lower in initial flexural rupture strength and also poorer in hydrolysis resistance and durability as compared to Example 1 because the mixing amount of the hydrotalcite compound in the resin composition of Comparative Example 7 was too large.

The resin composition of Comparative Example 8 was poorer in hydrolysis resistance and durability as compared to Example 14 because the mixing amount of the monocarbodiimide compound in the resin composition of Comparative Example 8 was too small.

The resin composition of Comparative Example 9 was lower in initial flexural rupture strength and poorer in hydrolysis resistance and durability as compared to Example 1 because the mixing amount of the monocarbodiimide compound in the resin composition of Comparative Example 9 was too large.

The resin compositions of Comparative Examples 10 and 11 were poorer in hydrolysis resistance and durability as compared to Example 1 because in each the resin compositions of Comparative Examples 10 and 11, a polycarbodiimide compound was used in place of the monocarbodiimide compound.

The resin composition of Comparative Example 12 was poor in hydrolysis resistance and durability even when the jojoba oil was used because in the resin composition of Comparative Example 12, a polycarbodiimide compound was used in place of a monocarbodiimide compound.

The resin compositions of Comparative Examples 13 to 16 were poorer in hydrolysis resistance and durability as compared to Example 1 because in each of the resin compositions of Comparative Examples 13 to 16, an inorganic filler other than a hydrotalcite compound was used.

The resin composition of Comparative Example 17 was poorer in hydrolysis resistance and durability than the resin compositions of any Examples in each of which a monocarbodiimide compound was mixed in an amount of 4 parts by mass even when a polylactic acid resin having a low content of poly(D-lactic acid) was used because no hydrotalcite compound was mixed in the resin composition of Comparative Example 17.

The resin composition of Comparative Example 18 was poorer in hydrolysis resistance and durability than Example 21 even when a polylactic acid resin having a low content of poly(D-lactic acid) was used because no hydrotalcite compound was mixed in the resin composition of Comparative Example 18.

The resin composition of Comparative Example 19 was poorer in exterior appearance evaluation and durability than Example 21 even when a polylactic acid resin having a low content of poly(D-lactic acid) was used because no hydrotalcite compound was mixed in the resin composition of Comparative Example 19.

The resin composition of Comparative Example 20 was poorer in hydrolysis resistance and durability than Example 21 even when a polylactic acid resin having a low content of poly(D-lactic acid) was used and further the jojoba oil was mixed because no hydrotalcite compound was mixed in the resin composition of Comparative Example 20.

Preparation of Cross-Linked Polylactic Acid Resin (P-1)

A double screw extruder (trade name: Model TEM37BS, manufactured by Toshiba Machine Co., Ltd.) was used, and 100 parts by mass of PLA1 was fed from a root feed opening of the extruder, and a solution prepared by mixing 0.1 part by mass of PBE as a (meth)acrylic aid ester compound, 0.2 part by mass of PDE as a peroxide and 2 parts by mass of (M-1) as a plasticizer was injected into the extruder from a midway position of the kneading machine by using a pump, and the resulting mixture was melt-kneaded and extruded under the conditions that the processing temperature was 190° C., the screw rotation number was 200 rpm and the discharge rate was 15 kg/h. Then, the discharged resin was cut into a pellet shape, and thus the pellets of the cross-linked polylactic acid resin (P-1) were obtained.

Preparation of Cross-Linked Polylactic Acid Resins (P-2) to (P-4)

The pellets of the cross-linked polylactic acid resins (P-2) to (P-4) were obtained in the same manner as in the case of (P-1) except that the type of the polylactic acid resin, and the mixing amounts of the (meth)acrylic acid ester compound and the silane compound were altered as shown in Table 8.

TABLE 8

| Composition | Type | P-1 | P-2 | P-3 | P-4 |
|---|---|---|---|---|---|
| Polylactic acid | PLA1 | 100 | 100 | 100 | — |
| | PLA3 | — | — | — | 100 |
| Peroxide | PBD | 0.2 | 0.2 | 0.2 | 0.2 |
| (Meth)acrylic acid | PDE | 0.1 | — | 0.1 | 0.1 |
| ester compound | | | | | |
| Silane compound | KBM | — | 0.1 | 0.1 | 0.1 |
| Plasticizer | M-1 | 2 | 2 | 2 | 2 |

(1) Numerical values of composition in the table are given in units of parts by mass.
(2) “—” indicates no mixing.

### Example 27

First, 100 parts by mass of a cross-linked polylactic acid resin as a polylactic acid resin, 4 parts by mass of CD1 as a monocarbodiimide compound, 0.5 part by mass of A as a hydrotalcite compound were dry blended together, and then melt-kneaded with a double screw extruder (trade name: Model TEM37BS, manufactured by Toshiba Machine Co., Ltd.) under the conditions of a temperature of 190° C. and a screw rotation number of 180 rpm. After performing the melt-kneading, the molten resin extruded from the end of the extruder was taken up in a strand shape, cooled by passing the strand-shaped molten resin through a vat filled with cooling water, then cut into a pellet shape and vacuum dried at 70° C. for 24 hours, and thus pellets (a polylactic acid-based resin composition) were obtained.

### Examples 28 and 29

In each of Examples 28 and 29, pellets of a polylactic acid-based resin composition were obtained in the same manner as in Example 27 except that as shown in Table 9, as the hydrotalcite compound, B and C were used in place of A in Examples 28 and 29, respectively.

### Example 30

Pellets of a polylactic acid-based resin composition were obtained in the same manner as in Example 27 except that 2 parts by mass of the refined jojoba oil was mixed.

### Example 31

Pellets of a polylactic acid-based resin composition were obtained in the same manner as in Example 27 except that CD2 was used as the monocarbodiimide compound.

### Examples 32 to 34

In each of Examples 32 to 34, pellets of a polylactic acid-based resin composition were obtained in the same manner as in Example 27 except that as shown in Table 10, the cross-linked polylactic acid resin (P-1) was replaced with (P-2), (P-3) and (P-4) in Examples 32 to 34, respectively.

### Examples 35 and 36

In each of Examples 35 and 36, pellets of a polylactic acid-based resin composition were obtained in the same manner as in Example 34 except that as shown in Table 10, as the hydrotalcite compound, B and C were used in place of A, in Examples 35 and 36, respectively.

### Example 37

Pellets of a polylactic acid-based resin composition were obtained in the same manner as in Example 34 except that 2 parts by mass of the refined jojoba oil was mixed.

### Example 38

Pellets of a polylactic acid-based resin composition were obtained in the same manner as in Example 27 except that the mixing amount of the monocarbodiimide compound CD1 was altered to 2 parts by mass.

### Example 39

Pellets of a polylactic acid-based resin composition were obtained in the same manner as in Example 27 except that the mixing amount of the monocarbodiimide compound CD1 was altered to 8 parts by mass.

The compositions, the values of the properties and the evaluation results of the polylactic acid-based resin compositions obtained in Examples 27 to 31 are shown in Table 9. The compositions, the values of the properties and the evaluation results of the polylactic acid-based resin compositions obtained in Examples 32 to 39 are shown in Table 10.

TABLE 9

| | | | | | | | | | | | Hydrolysis resistance | | | | | |
|---|---|---|---|---|---|---|---|---|---|---|---|---|---|---|---|---|
| | | | | | | | | | | | Upper row: Flexural rupture strength after | | | | | Heat |
| | | | | | | | | | | | humidity-heat test (MPa) | | | | | resistance |
| | Composition (parts by mass) | | | | | | | | | | Middle row: Flexural strength retention rate (%) | | | | | Deflection |
| | Polylactic | | | | Carbodiimide | | Hydrotalcite | | | Refined | Lower row: Exterior appearance evaluation | | | | | temperature |
| Exam- | acids | | | | compounds | | compounds | | | jojoba | After | After | After | After | After | under load |
| ple | P-1 | P-2 | P-3 | P-4 | CD1 | CD2 | A | B | C | oil | 0 h | 500 h | 1000 h | 1500 h | 2000 h | (° C.) |
| 27 | 100 | — | — | — | 4 | — | 0.5 | — | — | — | 120 | 120 | 120 | 113 | 109 | 125 |
| | | | | | | | | | | | 100% | 100% | 100% | 94% | 91% | |
| | | | | | | | | | | | E | E | E | E | E | |
| 28 | 100 | — | — | — | 4 | — | — | 0.5 | — | — | 123 | 123 | 122 | 116 | 111 | 128 |
| | | | | | | | | | | | 100% | 100% | 99% | 94% | 90% | |
| | | | | | | | | | | | E | E | E | E | E | |
| 29 | 100 | — | — | — | 4 | — | — | — | 0.5 | — | 118 | 116 | 116 | 110 | 105 | 128 |
| | | | | | | | | | | | 100% | 98% | 98% | 93% | 89% | |
| | | | | | | | | | | | E | E | E | E | E | |
| 30 | 100 | — | — | — | 4 | — | 0.5 | — | — | 2 | 116 | 116 | 116 | 111 | 108 | 119 |
| | | | | | | | | | | | 100% | 100% | 100% | 96% | 93% | |
| | | | | | | | | | | | E | E | E | E | E | |
| 31 | 100 | — | — | — | — | 4 | 0.5 | — | — | — | 121 | 119 | 119 | 111 | 103 | 125 |
| | | | | | | | | | | | 100% | 98% | 98% | 92% | 85% | |
| | | | | | | | | | | | E | E | E | E | E | |

—: Indicating no mixing.

TABLE 10

| | | | | | | | | | | | Hydrolysis resistance | | | | | |
|---|---|---|---|---|---|---|---|---|---|---|---|---|---|---|---|---|
| | | | | | | | | | | | Upper row: Flexural rupture strength after | | | | | Heat |
| | | | | | | | | | | | humidity-heat test (MPa) | | | | | resistance |
| | Composition (parts by mass) | | | | | | | | | | Middle row: Flexural strength retention rate (%) | | | | | Deflection |
| | Polylactic | | | | Carbodiimide | | Hydrotalcite | | | Refined | Lower row: Exterior appearance evaluation | | | | | temperature |
| Exam- | acids | | | | compounds | | compounds | | | jojoba | After | After | After | After | After | under load |
| ple | P-1 | P-2 | P-3 | P-4 | CD1 | CD2 | A | B | C | oil | 0 h | 500 h | 1000 h | 1500 h | 2000 h | (° C.) |
| 32 | — | 100 | — | — | 4 | — | 0.5 | — | — | — | 126 | 126 | 124 | 122 | 114 | 132 |
| | | | | | | | | | | | 100% | 100% | 98% | 97% | 90% | |
| | | | | | | | | | | | E | E | E | E | E | |
| 33 | — | — | 100 | — | 4 | — | 0.5 | — | — | — | 122 | 122 | 122 | 116 | 112 | 127 |
| | | | | | | | | | | | 100% | 100% | 100% | 95% | 92% | |
| | | | | | | | | | | | E | E | E | E | E | |
| 34 | — | — | — | 100 | 4 | — | 0.5 | — | — | — | 128 | 128 | 125 | 123 | 119 | 132 |
| | | | | | | | | | | | 100% | 100% | 98% | 96% | 93% | |
| | | | | | | | | | | | E | E | E | E | E | |
| 35 | — | — | — | 100 | 4 | — | — | 0.5 | — | — | 126 | 126 | 125 | 121 | 116 | 131 |
| | | | | | | | | | | | 100% | 100% | 99% | 96% | 92% | |
| | | | | | | | | | | | E | E | E | E | E | |
| 36 | — | — | — | 100 | 4 | — | — | — | 0.5 | — | 128 | 127 | 126 | 122 | 116 | 131 |
| | | | | | | | | | | | 100% | 99% | 98% | 95% | 91% | |
| | | | | | | | | | | | E | E | E | E | E | |
| 37 | — | — | — | 100 | 4 | — | 0.5 | — | — | 2 | 122 | 122 | 122 | 120 | 117 | 127 |
| | | | | | | | | | | | 100% | 100% | 100% | 98% | 96% | |
| | | | | | | | | | | | E | E | E | E | E | |
| 38 | 100 | — | — | — | 2 | — | 0.5 | — | — | — | 124 | 124 | 124 | 113 | 100 | 127 |
| | | | | | | | | | | | 100% | 100% | 100% | 91% | 81% | |
| | | | | | | | | | | | E | E | E | E | G | |
| 39 | 100 | — | — | — | 8 | — | 0.5 | — | — | — | 110 | 110 | 110 | 108 | 106 | 122 |
| | | | | | | | | | | | 100% | 100% | 100% | 98% | 96% | |
| | | | | | | | | | | | E | E | E | E | G | |

—: Indicating no mixing.

### Comparative Example 21

Pellets of a polylactic acid-based resin composition were obtained in the same manner as in Example 27 except that no hydrotalcite compound was used.

### Comparative Example 22

Pellets of a polylactic acid-based resin composition were obtained in the same manner as in Example 27 except that no carbodiimide compound was used.

### Comparative Example 23

Pellets of a polylactic acid-based resin composition were obtained in the same manner as in Example 27 except that the mixing amount of the hydrotalcite compound A was altered to 0.03 part by mass.

### Comparative Example 24

Pellets of a polylactic acid-based resin composition were obtained in the same manner as in Example 27 except that the mixing amount of the hydrotalcite compound A was altered to 3.0 parts by mass.

### Comparative Example 25

Pellets of a polylactic acid-based resin composition were obtained in the same manner as in Example 27 except that the mixing amount of the monocarbodiimide compound CD1 was altered to 0.08 part by mass and the mixing amount of the hydrotalcite compound A was altered to 1.0 part by mass.

### Comparative Example 26

Pellets of a polylactic acid-based resin composition were obtained in the same manner as in Example 27 except that the mixing amount of the monocarbodiimide compound CD1 was altered to 12 parts by mass.

### Comparative Example 27

Pellets of a polylactic acid-based resin composition were obtained in the same manner as in Example 34 except that no hydrotalcite compound was used.

### Comparative Example 28

Pellets of a polylactic acid-based resin composition were obtained in the same manner as in Example 37 except that no hydrotalcite compound was used.

### Comparative Example 29

Pellets of a polylactic acid-based resin composition were obtained in the same manner as in Example 34 except that the mixing amount of the hydrotalcite compound A was set at 0.03 part by mass.

### Comparative Example 30

Pellets of a polylactic acid-based resin composition were obtained in the same manner as in Example 34 except that no monocarbodiimide compound CD1 was used.

### Comparative Example 31

Pellets of a polylactic acid-based resin composition were obtained in the same manner as in Example 34 except that the mixing amount of the monocarbodiimide compound CD1 was set at 0.08 part by mass.

### Comparative Example 32 and 33

In each of Comparative Examples 32 and 33, pellets of a polylactic acid-based resin composition were obtained in the same manner as in Example 34 except that as shown in Table 12, the monocarbodiimide compound CD1 was replaced with the polycarbodiimide compounds CD3 and CD4 in Comparative Examples 32 and 33, respectively.

### Comparative Example 34

Pellets of a polylactic acid-based resin composition were obtained in the same manner as in Example 37 except that the monocarbodiimide compound CD1 was replaced with the polycarbodiimide compound CD3.

The compositions, the values of the properties and the evaluation results of the polylactic acid-based resin compositions obtained in Comparative Examples 21 to 26 are shown in Table 11. The compositions, the values of the properties and the evaluation results of the polylactic acid-based resin compositions obtained in Examples 27 to 34 are shown in Table 12.

TABLE 11

| | | | | | | | | | Hydrolysis resistance | | | | | |
|---|---|---|---|---|---|---|---|---|---|---|---|---|---|---|
| | | | | | | | | | Upper row: Flexural rupture strength after | | | | | Heat |
| | | | | | | | | | humidity-heat test (MPa) | | | | | resistance |
| | Composition (parts by mass) | | | | | | | | Middle row: Flexural strength retention rate (%) | | | | | Deflection |
| Compar- | Polylactic | | Carbodiimide | | | | Hydrotalcite | Refined | Lower row: Exterior appearance evaluation | | | | | temperature |
| ative | acids | | compounds | | | | compounds | jojoba | After | After | After | After | After | under load |
| Example | P-1 | P-4 | CD1 | CD2 | CD3 | CD4 | A | oil | 0 h | 500 h | 1000 h | 1500 h | 2000 h | (° C.) |
| 21 | 100 | — | 4 | — | — | — | — | — | 120 | 120 | 110 | 97 | 72 | 122 |
| | | | | | | | | | 100% | 100% | 92% | 81% | 60% | |
| | | | | | | | | | E | E | E | G | A | |
| 22 | 100 | — | — | — | — | — | 0.5 | — | 125 | 52 | / | / | / | 122 |
| | | | | | | | | | 100% | 42% | / | / | / | |
| | | | | | | | | | E | P | / | / | / | |
| 23 | 100 | — | 4 | — | — | — | 0.03 | — | 122 | 122 | 115 | 95 | 72 | 124 |
| | | | | | | | | | 100% | 100% | 94% | 78% | 59% | |
| | | | | | | | | | E | E | E | G | A | |
| 24 | 100 | — | 4 | — | — | — | 3 | — | 127 | 102 | 80 | / | / | 125 |
| | | | | | | | | | 100% | 80% | 63% | / | / | |
| | | | | | | | | | E | G | A | / | / | |
| 25 | 100 | — | 0.08 | — | — | — | 1 | — | 125 | 78 | 60 | / | / | 122 |
| | | | | | | | | | 100% | 62% | 48% | / | / | |
| | | | | | | | | | E | G | A | / | / | |
| 26 | 100 | — | 12 | — | — | — | 0.5 | — | 106 | 105 | 106 | 104 | 102 | 115 |
| | | | | | | | | | 100% | 99% | 100% | 98% | 96% | |
| | | | | | | | | | E | E | A | P | P | |

—: Indicating no mixing.
/: Indicating strength too low to measure.

TABLE 12

| | | | | | | | | | Hydrolysis resistance | | | | | |
|---|---|---|---|---|---|---|---|---|---|---|---|---|---|---|
| | | | | | | | | | Upper row: Flexural rupture strength after | | | | | Heat |
| | | | | | | | | | humidity-heat test (MPa) | | | | | resistance |
| | Composition (parts by mass) | | | | | | | | Middle row: Flexural strength retention rate (%) | | | | | Deflection |
| Compar- | Polylactic | | Carbodiimide | | | | Hydrotalcite | Refined | Lower row: Exterior appearance evaluation | | | | | temperature |
| ative | acids | | compounds | | | | compounds | jojoba | After | After | After | After | After | under load |
| Example | P-1 | P-4 | CD1 | CD2 | CD3 | CD4 | A | oil | 0 h | 500 h | 1000 h | 1500 h | 2000 h | (° C.) |
| 27 | — | 100 | 4 | — | — | — | — | — | 127 | 126 | 120 | 100 | 82 | 132 |
| | | | | | | | | | 100% | 99% | 94% | 79% | 65% | |
| | | | | | | | | | E | E | E | G | A | |
| 28 | — | 100 | 4 | — | — | — | — | 2 | 120 | 120 | 114 | 98 | 82 | 131 |
| | | | | | | | | | 100% | 100% | 95% | 82% | 68% | |
| | | | | | | | | | E | E | E | G | A | |
| 29 | — | 100 | 4 | — | — | — | 0.03 | — | 129 | 128 | 125 | 108 | 83 | 132 |
| | | | | | | | | | 100% | 99% | 97% | 84% | 64% | |
| | | | | | | | | | E | E | E | G | A | |
| 30 | — | 100 | | — | — | — | 0.5 | — | 128 | 53 | / | / | / | 129 |
| | | | | | | | | | 100% | 41% | / | / | / | |
| | | | | | | | | | E | P | / | / | / | |
| 31 | — | 100 | 0.08 | — | — | — | 1.0 | — | 126 | 86 | 67 | / | / | 129 |
| | | | | | | | | | 100% | 68% | 53% | / | / | |
| | | | | | | | | | E | G | A | / | / | |
| 32 | — | 100 | — | — | 4 | — | 0.5 | — | 120 | 89 | 61 | / | / | 130 |
| | | | | | | | | | 100% | 74% | 51% | / | / | |
| | | | | | | | | | E | A | P | / | / | |
| 33 | — | 100 | — | — | — | 4 | 0.5 | — | 124 | 88 | 58 | / | / | 127 |
| | | | | | | | | | 100% | 71% | 47% | / | / | |
| | | | | | | | | | E | A | P | / | / | |
| 34 | — | 100 | — | — | 4 | — | 0.5 | 2 | 117 | 90 | 63 | / | / | 127 |
| | | | | | | | | | 100% | 77% | 54% | / | / | |
| | | | | | | | | | E | A | P | / | / | |

—: Indicating no mixing.
/: Indicating strength too low to measure.

As can be seen from Tables 9 to 12, the resin compositions of Examples 27 to 39 were each a composition in which a cross-linked polylactic acid resin, a monocarbodiimide compound and a hydrotalcite compound were mixed in specific proportions, and hence the obtained molded articles from the resin compositions were high in the initial flexural rupture strength, and even after an elapsed time of 2000 hours under the conditions of 70° C. and a relative humidity of 95%, had a flexural strength retention rate of 80% or more and were excellent in hydrolysis resistance. The aforementioned molded articles were able to retain satisfactory exterior appearance for a longer term than the molded articles of Comparative Examples, and were also excellent in durability and heat resistance. The hydrolysis resistance and the heat resistance of the resin composition of each of Examples 27 to 39 were drastically improved as compared to the resin compositions of Examples 1 to 24 in each of which a not cross-linked polylactic acid resin was used.

In each of the resin compositions of Examples 30 and 37, the jojoba oil was further mixed in an appropriate amount, and hence the molded articles obtained from these resin compositions were higher in the flexural strength retention rates after elapsed times of 1500 hours and 2000 hours and were furthermore excellent in hydrolysis resistance as compared to Examples 27 and 34.

In each of the resin compositions of Examples 34 to 37, the proportion of poly(D-lactic acid) in the cross-linked polylactic acid resin was as low as 0.1 mol %, and hence the crystallinity was improved, and as compared to Examples 27 to 30, the molded articles obtained from these resin compositions were more excellent in heat resistance, higher in the flexural strength retention rates after an elapsed time of 2000 hours and furthermore excellent in hydrolysis resistance.

The resin composition of Comparative Example 21 was poorer in hydrolysis resistance and durability as compared to Examples 27 to 39 because no hydrotalcite compound was mixed in the resin composition of Comparative Example 21.

The resin compositions of Comparative Examples 22 and 30 were significantly poorer in hydrolysis resistance and durability than any Examples because no monocarbodiimide compound was mixed in each of the resin compositions of Comparative Examples 22 and 30.

The resin composition of Comparative Example 23 was poorer in hydrolysis resistance and durability as compared to Example 27 because the mixing amount of the hydrotalcite compound in the resin composition of Comparative Example 23 was too small.

The resin composition of Comparative Example 24 was lower in the initial flexural rupture strength and poorer in hydrolysis resistance and durability as compared to Example 27 because the mixing amount of the hydrotalcite compound in the resin composition of Comparative Example 24 was too large.

The resin compositions of Comparative Examples 25 and 31 were poor in hydrolysis resistance and durability because the mixing amount of the monocarbodiimide compound in each of the resin compositions of Comparative Examples 25 and 31 was too small.

The resin composition of Comparative Example 26 was lower in the initial flexural rupture strength and poorer in hydrolysis resistance and durability as compared to Example 27 because the mixing amount of the monocarbodiimide compound in the resin composition of Comparative Example 26 was too large.

The resin compositions of Comparative Examples 27 and 28 and the resin composition of Comparative Example 29 were poorer in hydrolysis resistance and durability than the resin compositions of any Examples in each of which a monocarbodiimide compound was mixed in an amount of 4 parts by mass although a polylactic acid resin having a low content of poly(D-lactic acid) was used both in the resin compositions of Examples 27 and 28 and in the resin composition of Comparative Example 29, because no hydrotalcite compound was mixed in the resin compositions of Comparative Examples 27 and 28, and because the mixing amount of the hydrotalcite compound in the resin composition of Comparative Example 29 was too small.

The resin compositions of Comparative Examples 32 and 33 were significantly poorer in hydrolysis resistance and durability as compared to Example 34 because the resin compositions of Comparative Examples 32 and 33 each used a polycarbodiimide compound in place of a monocarbodiimide compound.

The resin composition of Comparative Example 34 was significantly poorer in hydrolysis resistance and durability as compared to Example 34 even when the jojoba oil was used because the resin composition of Comparative Example 34 used a polycarbodiimide compound in place of a monocarbodiimide compound.

The resin composition of Example 27 using a cross-linked polylactic acid resin was more excellent in hydrolysis resistance and heat resistance than Example 25 in which a molded article obtained from a resin composition using a not cross-linked polylactic acid resin was subjected to an annealing treatment. The resin composition of Example 37 using a cross-linked polylactic acid resin was more excellent in hydrolysis resistance and heat resistance than Example 26 in which a molded article obtained from a resin composition using a not cross-linked polylactic acid resin was subjected to an annealing treatment. In other words, by adopting a resin composition comprising a cross-linked polylactic acid resin, it is possible to obtain with a simple step a molded article having hydrolysis resistance, durability and heat resistance.

As described above, it has been revealed that by using a polylactic acid resin, a monocarbodiimide compound and a hydrotalcite compound in combination in appropriate amounts, it is possible to obtain a molded article more excellent in mechanical properties (strength) and drastically improved in hydrolysis resistance, free from disadvantageous occurrence of cracking and the like with respect to exterior appearance and improved in durability as compared to molded articles obtained from hitherto known polylactic acid-based resin compositions.

It has also been revealed that the mixing of the jojoba oil with the above-described polylactic acid-based resin composition further improves the hydrolysis resistance and the durability.

It has also been revealed that the use of a cross-linked polylactic acid resin as the polylactic resin in the above-described polylactic acid-based resin composition makes the heat resistance more excellent and improves the hydrolysis resistance and the durability.

It has also been revealed that the use of a polylactic acid resin in which the content ratio between poly(L-lactic acid) and poly(D-lactic acid), the L/D ratio, falls within a range from 99.95/0.05 to 95/5, as the polylactic acid resin in the above-described polylactic acid-based resin composition makes the heat resistance more excellent and improves the hydrolysis resistance and the durability.

### INDUSTRIAL APPLICABILITY

According to the present invention, it is possible to obtain a polylactic acid-based resin composition extremely excellent in hydrolysis resistance and durability, and it is possible to preferably use the polylactic acid-based resin composition as various molded articles in various applications. Moreover, polylactic acid is derived from plant, and hence can contribute to alleviation of environmental load and prevention of depletion of petroleum resources.

1. A polylactic acid-based resin composition comprising a polylactic acid resin, a monocarbodiimide compound and a hydrotalcite compound,
wherein a content of the monocarbodiimide compound is 0.1 to 10 parts by mass in relation to 100 parts by mass of the polylactic acid resin and a content of the hydrotalcite compound is 0.05 to 2 parts by mass in relation to 100 parts by mass of the polylactic acid resin.

2. The polylactic acid-based resin composition according to claim 1,
wherein the polylactic acid resin is a cross-linked polylactic acid resin, and
the polylactic acid-based resin composition comprises a (meth)acrylic acid ester compound and/or a silane compound having two or more functional groups selected from an alkoxy group, an acryl group, a methacryl group and a vinyl group.

3. The polylactic acid-based resin composition according to claim 1,
wherein the polylactic acid-based resin composition comprises a jojoba oil, and
a content of the jojoba oil is 0.1 to 10 parts by mass in relation to 100 parts by mass of the polylactic acid resin.

4. A molded article formed of the polylactic acid-based resin composition according to claim 1.

5. A molded article formed of the polylactic acid-based resin composition according to any one of claim 2.

6. A molded article formed of the polylactic acid-based resin composition according to any one of claim 3.

7. The polylactic acid-based resin composition according to claim 2,
wherein the polylactic acid-based resin composition comprises a jojoba oil, and
a content of the jojoba oil is 0.1 to 10 parts by mass in relation to 100 parts by mass of the polylactic acid resin.

8. A molded article formed of the polylactic acid-based resin composition according to any one of claim 7.
